(19) United States
(12) Patent Application Publication
(10) Pub. No.: US 2026/0022555 A1
(43) Pub. Date: Jan. 22, 2026

(54) SOUND-ABSORBING MEMBER

(71) Applicant: Yamamoto Company Limited, Higashiosaka-shi, Osaka (JP)

(72) Inventors: Yoshikiyo Yamamoto, Higashiosaka-shi (JP); Fukuji Miyasato, Higashiosaka-shi (JP); Satoshi Mizuguchi, Kakogawa-shi (JP)

(73) Assignee: Yamamoto Company Limited, Higashiosaka-shi, Osaka (JP)

(21) Appl. No.: 18/993,725

(22) PCT Filed: Aug. 17, 2023
(86) PCT No.: PCT/JP2023/029769

§ 371 Date: Jan. 13, 2025

(30) Foreign Application Priority Data
Aug. 21, 2022 (JP) 2022-131424

(51) Int. Cl. E04B 1/86; G10K 11/162

(52) U.S. Cl. CPC E04B 1/86; G10K 11/162

(57) ABSTRACT

The sound-absorbing member (1) has a front face portion (2) toward a sound source and having an X-Y plane, and a back face portion (4) arranged such that a backside air layer (3) having a thickness in a Z direction intervenes between the back face portion and said front face portion (2); wherein, at the front face portion (2), a plurality of slits (5) that communicate with the backside air layer (3) and that are of prescribed lengths are provided at prescribed spacings, and vented chambers (6) which induce and contain diffracted waves from sound incident thereon from said slits (5) are provided so as to lie in the X-Y plane and have prescribed thicknesses in the Z direction.

### TECHNICAL FIELD

The present invention relates to a sound-absorbing member which may be used in soundproof walls for highways or interior walls for indoor corridors and the like.

### BACKGROUND ART

Conventional sound-absorbing members include those described, for example, at Japanese Patent Application Publication Kokai No. 2022-84524 (Patent Reference No. 1). Such conventional sound-absorbing members, which are employed in sound-absorbing walls installed at sides of roads, have been such that sound-absorbing material is provided at the interior of a boxlike panel body which is constituted from a rear face portion and side face portions, and from a front face portion in which a louver or other such hole is formed.

In terms of materials, the foregoing conventional sound-absorbing technologies have employed fibers, foam materials, thin films, and so forth; in terms of their structure, they have been thermal energy conversion methodologies involving resonance, vibration, friction, and the like. In addition, the conventional technologies have been such that such principles were employed to attempt solutions by causing the advancing sound to proceed linearly from the front face portion toward the rear face portion.

Accordingly, conventional approaches have been such that thickness of the boxlike panel main body has been large. As installation sites, there has been demand for thin sound-absorbing panels in situations where these are to be installed at wall faces and ceilings not subject to wind load in conference rooms, machine rooms, gymnasiums, arenas, public routes, air conditioning facilities, and so forth.

However, reduction of thickness has not easily been achieved with the conventional technology described at Patent Reference No. 1.

On the other hand, situations in which reduction of thickness has been attempted include those which are described at Japanese Patent Application Publication Kokai No. 2003-108145 (Patent Reference No. 2). At this soundproof member, reduction in thickness and weight was attempted by arranging two porous metal plates spaced an appropriate length from a face panel portion of a stock material having a given sectional profile to achieve a soundproofing effect due to the Helmholtz resonance principle and the viscous damping principle.

However, because that which is described at Patent Reference No. 2 was such that thickness of the stock material having the given sectional profile was extremely large, there was a limit to how much reduction in thickness could be achieved. Furthermore, it also did not permit adequate soundproofing effect to be achieved unless thickness of the air layer between the face panel portion and the porous metal plates was large.

### PRIOR ART REFERENCES

### Patent References

Patent Reference No. 1: Japanese Patent Application Publication Kokai No. 2022-84524

Patent Reference No. 2: Japanese Patent Application Publication Kokai No. 2003-108145

### SUMMARY OF INVENTION

### Problem To Be Solved By Invention

Because that which is described at the foregoing Patent Reference Nos. 1 and 2 employed the principle whereby sound-absorbing effect was obtained by causing the advancing sound to proceed linearly from the front face portion toward the rear face portion, they required that the air layer at the back be thick. and there was a limit to how much reduction in thickness could be achieved.

It is therefore an object of the present invention to provide a sound-absorbing member which is based not on the conventional linearly advancing principle but on a novel diffraction principle, and which is of reduced thickness between the front face portion and the rear face portion.

### Means For Solving Problem

To achieve the foregoing object, the present invention employs the following means. To wit, a sound-absorbing member in accordance with the present invention has a front face portion toward a sound source and having an X-Y plane, and a back face portion arranged such that a backside air layer having a thickness in a Z direction intervenes between the back face portion and said front face portion; wherein, at the front face portion, a plurality of slits that communicate with the backside air layer and that are of prescribed lengths are provided at prescribed spacings, and vented chambers which induce and contain diffracted waves from sound incident thereon from said slits are provided so as to lie in the X-Y plane and have prescribed thicknesses in the Z direction.

It is preferred that the vented chambers be partitioned into a plurality thereof in the Y direction and be continuous in the X direction; and that the slits be linear. and intersect the X direction at 45 degrees to 135 degrees.

It is preferred that multiple layers of the vented chambers be provided in the Z direction.

It is preferred that the front face portion be formed from corrugated board, metal material, or synthetic resin material.

It is preferred that sound-absorbing material be contained within the vented chambers.

### Benefit Of Invention

The present invention provides the benefit that, due to its employment of a principle whereby sound is diffracted, it permits greater reduction in thickness than is the case with the conventional linear arrangement.

### BRIEF DESCRIPTION OF DRAWINGS

FIG. 1 Front view of sound-absorbing member showing an embodiment of the present invention.

FIG. 2 Sectional views of various sound-absorbing members as exemplified by that at FIG. 1.

FIG. 3 Various sectional views in which front face portions are constituted from corrugated board.

FIG. 4 Various sectional views in which front face portions are constituted from aluminum stock material having particular sectional profiles.

FIG. 5 Various sectional views in which front face portions are constituted from composite stacked panels.

FIG. 6 Perspective view of front face portion for explaining a diffraction principle in accordance with the present invention.

FIG. 7 Drawing to assist in describing diffraction principle.

FIG. 8 Front view of first test piece.

FIG. 9 Sectional view of first test piece.

FIG. 10 Graph of results of measurement of sound absorption coefficient of first test piece.

FIG. 11 Graph of results of measurement of sound absorption coefficient of first test piece.

FIG. 12 Front view of second test piece.

FIG. 13 Graph of results of measurement of sound absorption coefficient of second test piece.

FIG. 14 Graph of results of measurement of sound absorption coefficient of second test piece.

FIG. 15 Sectional view of third test piece.

FIG. 16 Graph of results of measurement of sound absorption coefficient of third test piece.

FIG. 17 Graph of results of measurement of sound absorption coefficient of third test piece.

FIG. 18 Front view of fourth test piece.

FIG. 19 Graph of results of measurement of sound absorption coefficient of fourth test piece.

FIG. 20 Graph of results of measurement of sound absorption coefficient of fourth test piece.

FIG. 21 Sectional view of fifth test piece.

FIG. 22 Graph of results of measurement of sound absorption coefficient of fifth test piece.

FIG. 23 Graph of results of measurement of sound absorption coefficient of fifth test piece.

FIG. 24 Sectional view of sixth test piece.

FIG. 25 Graph of results of measurement of sound absorption coefficient of sixth test piece.

FIG. 26 Graph of results of measurement of sound absorption coefficient of sixth test piece.

FIG. 27 Front view and sectional view of sound-absorbing member showing another embodiment of the present invention.

FIG. 28 Front view and sectional view of sound-absorbing member and constituent members thereof showing another embodiment of the present invention.

FIG. 29 Front view and sectional view of sound-absorbing member and constituent members thereof showing another embodiment of the present invention.

FIG. 30 Sectional view of front face portion showing another embodiment of the present invention.

FIG. 31 Perspective view of planar aluminum plate making up another embodiment of the present invention.

FIG. 32 Perspective view of front face piece formed by folding the aluminum plate at FIG. 31.

FIG. 33 Perspective view of back side of front face piece at FIG. 32.

FIG. 34 Perspective view of sound-absorbing member that has been provided with the front face piece shown in FIG. 32.

FIG. 35 Enlarged sectional view of region A in FIG. 34.

FIG. 36 Sectional view of sound-absorbing member that has been provided with an aluminum frame.

FIG. 37 Sectional view of sound-absorbing member in which back face portion is made up of galvanized sheet iron.

FIG. 38 Front view of spandrel-type sound-absorbing member.

FIG. 39 Sectional view of sound-absorbing member at FIG. 38.

FIG. 40 (a) is front view of seventh test piece; (b) is sectional view.

FIG. 41 Graph of results of measurement of sound absorption coefficient of seventh test piece.

FIG. 42 Graph of results of measurement of sound absorption coefficient of seventh test piece.

FIG. 43 (a) is front view of eighth test piece; (b) is sectional view.

FIG. 44 Graph of results of measurement of sound absorption coefficient of eighth test piece.

FIG. 45 Graph of results of measurement of sound absorption coefficient of eighth test piece.

FIG. 46 (a) is front view of ninth test piece; (b) is sectional view.

FIG. 47 Graph of results of measurement of sound absorption coefficient of ninth test piece.

FIG. 48 Graph of results of measurement of sound absorption coefficient of ninth test piece.

FIG. 49 (a) is front view of tenth test piece; (b) is sectional view.

FIG. 50 Graph of results of measurement of sound absorption coefficient of tenth test piece.

FIG. 51 Graph of results of measurement of sound absorption coefficient of tenth test piece.

FIG. 52 (a) is front view of eleventh test piece: (b) is sectional view.

FIG. 53 Graph of results of measurement of sound absorption coefficient of eleventh test piece.

FIG. 54 Graph of results of measurement of sound absorption coefficient of eleventh test piece.

FIG. 55 (a) is front view of twelfth test piece; (b) is sectional view.

FIG. 56 Graph of results of measurement of sound absorption coefficient of twelfth test piece.

FIG. 57 Graph of results of measurement of sound absorption coefficient of twelfth test piece.

FIG. 58 (a) is front view of thirteenth test piece; (b) is sectional view.

FIG. 59 Graph of results of measurement of sound absorption coefficient of thirteenth test piece.

FIG. 60 Graph of results of measurement of sound absorption coefficient of thirteenth test piece.

FIG. 61 (a) is front view of fourteenth test piece: (b) is sectional view.

FIG. 62 Graph of results of measurement of sound absorption coefficient of fourteenth test piece.

FIG. 63 Graph of results of measurement of sound absorption coefficient of fourteenth test piece.

### EMBODIMENTS FOR CARRYING OUT INVENTION

Below, embodiments of the present invention are described with reference to the drawings.

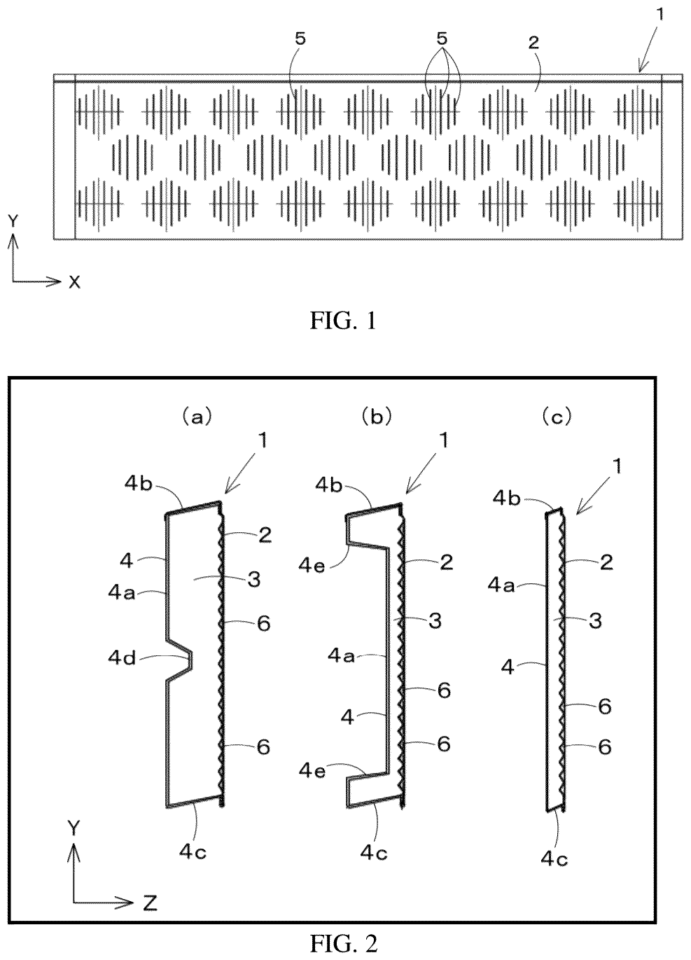

FIG. 1 is a front view of sound-absorbing member 1 which may be used in soundproof walls for highways or in indoor ceilings, walls, and so forth.

FIG. 2 is sectional views thereof, (a) and (b) at same drawing having structures for outdoor use which are capable of accommodating wind loads and other such external forces; (c) at same drawing having a cross-sectional structure for indoor use which may be used at sites not subject to wind load or the like (machine room soundproofing, partition walls, and so forth).

This sound-absorbing member 1 has front face portion 2 which is toward the source of a sound; and back face portion 4 which is arranged such that backside air layer 3 intervenes between it and this front face portion 2.

Note that the “X, Y, and Z directions” employed in the present invention are defined based on the X-Y coordinate system depicted in FIG. I and the Y-Z coordinate system depicted in FIG. 2. Furthermore, the X direction may sometimes be referred to as the “horizontal direction”; the Y direction may sometimes be referred to as the “vertical direction”; and the Z direction may sometimes be referred to as the “thickness direction.”

Front face portion 2 is constituted from a member that is plate-like in the X-Y plane and that is of prescribed thickness in the Z direction. Back face portion 4 has back face panel 4a which is arranged so as to be parallel to front face portion 2 such that backside air layer 3 intervenes therebetween in the Z direction; and top face panel 4b and bottom face panel 4c which extend toward the front face portion from the top and bottom ends of this back face panel 4a. The end portions of top face panel 4b and bottom face panel 4c are joined to the top and bottom ends of front face portion 2.

These have ribbed structures capable of accommodating wind loads, projecting rib 4d which protrudes toward front face portion 2 being formed at a central portion of back face panel 4a as shown at (a) in FIG. 2, and ribs 4e which protrude in directions opposite front face portion 2 being formed at the top and bottom portions of back face panel 4a as shown at (b) in same drawing. Because that which is shown at (c) of same drawing is for indoor use, it does not employ a ribbed structure.

A plurality of slits 5 that communicate with the foregoing backside air layer 3 and that are of prescribed length(s) are provided at prescribed spacing(s) at the foregoing front face portion 2. Furthermore, vented chambers 6 that induce and contain diffracted waves from sound incident thereon from slits 5 are provided at front face portion 2. These vented chambers 6 lie in the X-Y plane and have prescribed thickness(es) in the Z direction. Width of slit 5 is not greater than 0.5 mm.

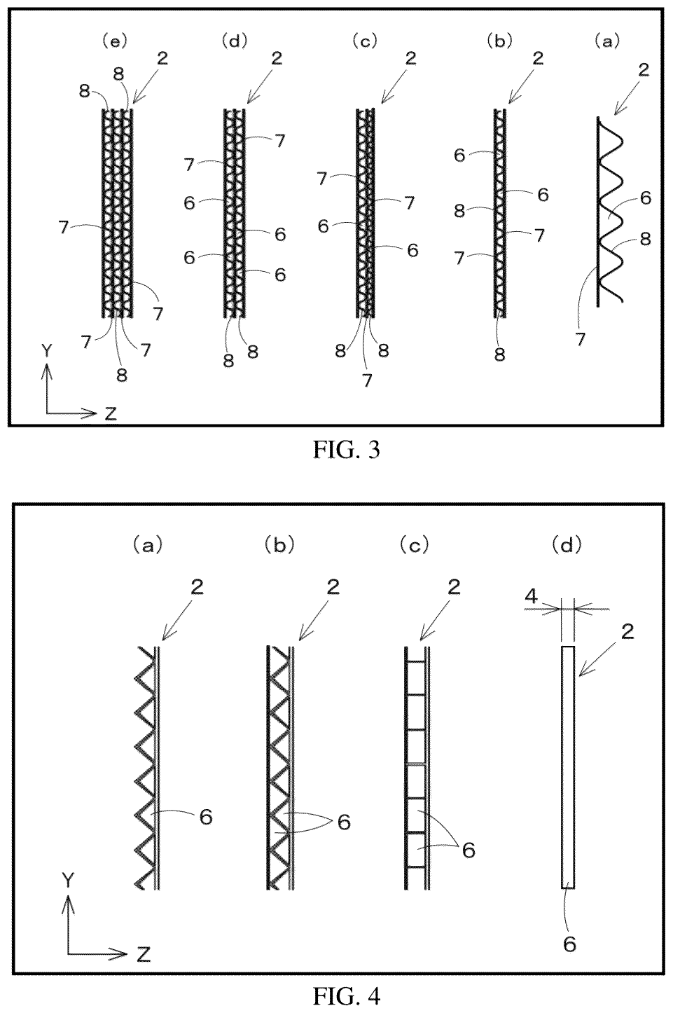

Various shapes for vented chambers 6 are shown at FIG. 3 through FIG. 5.

FIG. 3 shows situations in which front face portions 2 are constituted from corrugated board. (a) at same drawing is “single-face corrugated board” at which corrugating medium 8 which is formed so as to be of corrugated shape is laminated to a single ply of linerboard 7, the hollow portions of the corrugations forming vented chambers 6. (b) at same drawing is “double-face corrugated board” at which linerboard 7 is laminated to the tips of the corrugations of single-face corrugated board, the hollow portions of the conugations between plies 7, 7 of linerboard forming vented chambers 6. (c) and (d) at same drawing are “multi-double-face corrugated board” at which single-face corrugated board is laminated to one side of double-face corrugated board. (c) and (d) differ with respect to the magnitude of the pitch of the corrugations of the single-face corrugated board. (e) at same drawing is “multi-multi-double-face corrugated board” at which single-face corrugated board is laminated to one side of multi-double-face corrugated board.

The foregoing vented chambers 6 are partitioned into a plurality thereof in the Y direction and are continuous in the X direction; (c) through (e) show situations in which there are multiple layers of vented chambers 6 in the Z direction.

FIG. 4 shows situations in which front face portions 2 are constituted from aluminum stock material having particular sectional profiles. That which is shown at (a) in FIG. 4 has a cross-sectional shape corresponding to that at (a) in FIG. 3; and (b) and (c) at FIG. 4 have cross-sectional shapes corresponding to (b) at FIG. 3, vented chambers 6 which are partitioned into a plurality thereof in the Y direction being formed thereat. That which is shown at (d) in FIG. 4 is such that two aluminum plates are arranged in parallel with a prescribed separation therebetween in the Z direction, vented chamber 6 lying in the X-Y plane and having prescribed thickness in the Z direction, this not being partitioned into a plurality thereof in the Y direction.

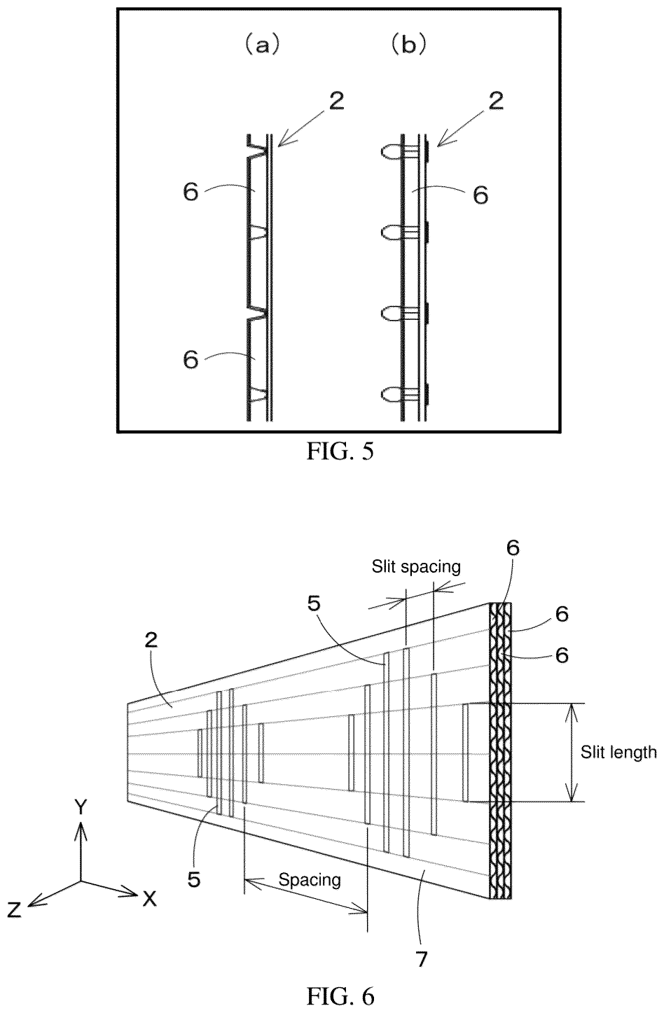

FIG. 5 shows situations in which front face portions 2 are constituted from composite stacked panels. These panels may be aluminum, galvanized sheet iron, SUS material, or plastic panels. Spaces between stacked panels constitute vented chambers 6.

Note that while situations have been shown by way of example in which front face portion 2 is constituted from corrugated board, metal material, or synthetic resin material, the present invention is not limited to situations in which this is constituted from such members.

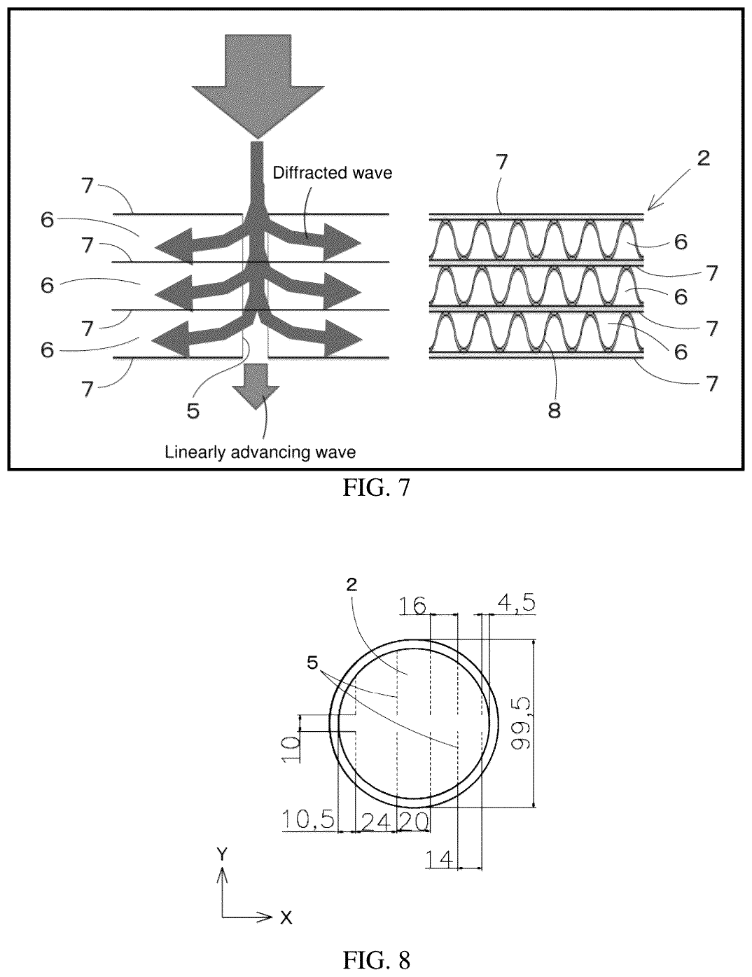

The phenomenon whereby sound is diffracted will be explained using FIG. 6 and FIG. 7.

When the gap is narrow, there will be much diffraction of sound behind the surface panel. This diffracted wave is structurally induced and contained therewithin, the acoustic energy being converted into heat. In other words, vented chamber(s) 6 are provided behind the surface panel, and sound absorption processing is carried out.

Front face portion 2 of the sound-absorbing member shown in FIG. 6 is formed from corrugated board having the cross-sectional shape shown at (e) in FIG. 3. The surface panel of this front face portion 2 is formed from linerboard 7, vented chambers 6 being partitioned into a plurality thereof in the Y direction and being continuous in the X direction, multiple layers thereof being provided in the Z direction.

Slits 5 which extend all the way therethrough in the thickness direction are provided at front face portion 2. Slits 5 have prescribed lengths in the Y direction, a plurality thereof being provided at prescribed spacing(s) in the X direction. Slits 5 are provided in such fashion as to intersect the X direction at 90 degrees. Where vented chambers 6 are continuous in the X direction, a condition which must be met is that slits 5 not be parallel to vented chambers 6. For this reason, from 45 degrees to 135 degrees will be optimal, 90 degrees being the norm. Note that slits 5 are formed so as to be coplanar, the widths thereof being not greater than 0.5 mm.

As shown in FIG. 7, a sound wave that advances linearly after entering thereinto from slit 5 will become a diffracted wave that is guided to vented chamber 6. At vented chamber 6, after the diffracted wave has been guided thereto and received thereby, the energy of the propagating sound is converted into thermal energy by way of friction, vibration, and/or other such physical forms of energy. resulting in absorption of the sound. Increase in performance can be achieved where processing (multistage processing in the Z direction) is carried out so as to cause the diffracted wave to not just be diffracted once but to be a twice-diffracted wave or a thrice-diffracted wave. This will make it possible to reduce the thickness of the backside air layer and to achieve a thinner structure for sound-absorbing member 1.

It is a principle of acoustics that a narrow gap causes occurrence of the phenomenon of diffraction, this being such that the lower the frequency the greater will be the amount of such diffraction. To take advantage of this principle, sound is guided to vented chamber 6, the sound being subjected to energy conversion at vented chamber 6. While a portion of the sound will also advance linearly, its effect will not be large where the structure employs three layers or more. With respect to the sound which enters vented chamber 6, because lengths of vented chambers 6 are varied (on the order of 20 mm to 200 mm), this widens the frequency bandwidth of the sound absorption coefficient. Thickness of sound-absorbing member 1 can be reduced even when used with low frequencies.

The situations shown in FIG. 8 through FIG. 26 pertain to results of measurements during testing performed under conditions of normal incidence. During this testing and measurement, sound absorption coefficient measurements were conducted under conditions of normal incidence using a Device No. A6001, Device Configuration/Model No. Bruel & Kjaer Type 4206 “Sound Absorption Coefficient Measurement System” at Osaka Research Institute of Industrial Science and Technology (a Local Incorporated Administrative Agency). Note that the “test pieces” employed at this Sound Absorption

Coefficient Measurement System were 100 mm in diameter. The measurement technique was the two-microphone method (transfer function technique). The standards followed were ISO 10534 and ASTME 1050. The range of frequencies tested was 100 Hz to 1600 Hz.

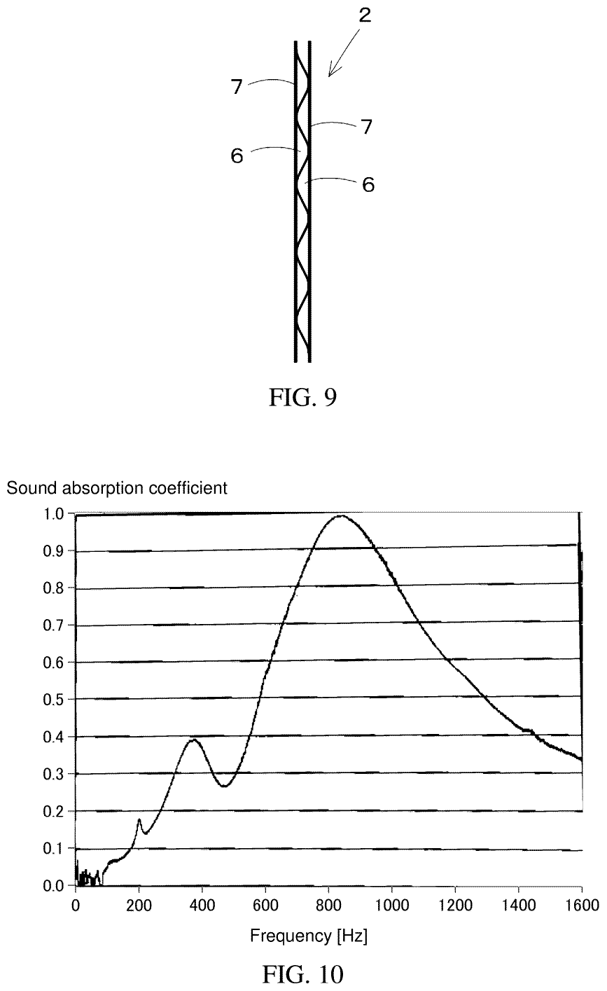

That which is shown in FIG. 8 and FIG. 9 is a first test piece that was used with the foregoing “Sound Absorption Coefficient Measurement System.” FIG. 8 is a front view of the test piece (front face portion 2); FIG. 9 is a sectional view of the test piece (front face portion 2). This first test piece was constituted from fireproof corrugated board at which front face portion 2 was “double-face corrugated board.” Thickness of front face portion 2 was 3 mm. At this test device, “backside air layer 3” was formed at the rear face of this test piece.

Vented chamber 6 formed at front face portion 2 was continuous in the X direction, and was partitioned into a plurality thereof in the Y direction. Slits 5 intersected the X direction at 90 degrees. Slit width was 0.5 mm. The spacing of slits 5 was as shown in FIG. 8.

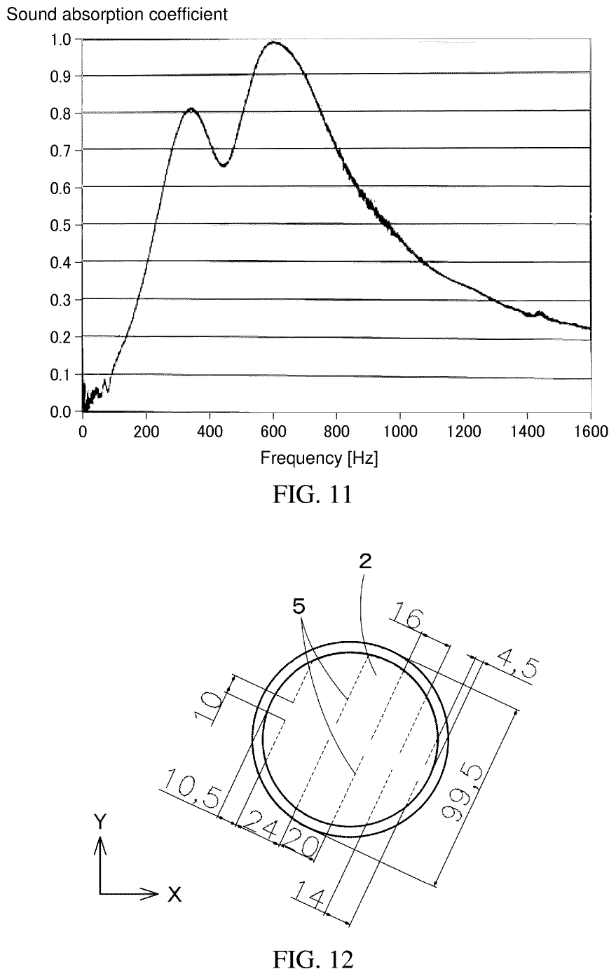

FIG. 10 and FIG. 11 are graphs of the results of measurements made during testing under conditions of normal incidence with the foregoing first test piece. The vertical axis is sound absorption coefficient; the horizontal axis is frequency. At FIG. 10, the backside air layer was made to be 30 mm, and the representative frequency was 850 Hz. At FIG. 11, the backside air layer was made to be 60 mm, and the representative frequency was 600 Hz.

FIG. 12 is a front view of a second test piece. At this second test piece, vented chamber 6 was continuous in the X direction. and the angle with which slits 5 intersected the X axis was 60 degrees. Because the sectional view thereof would be the same as FIG. 9, it is not shown.

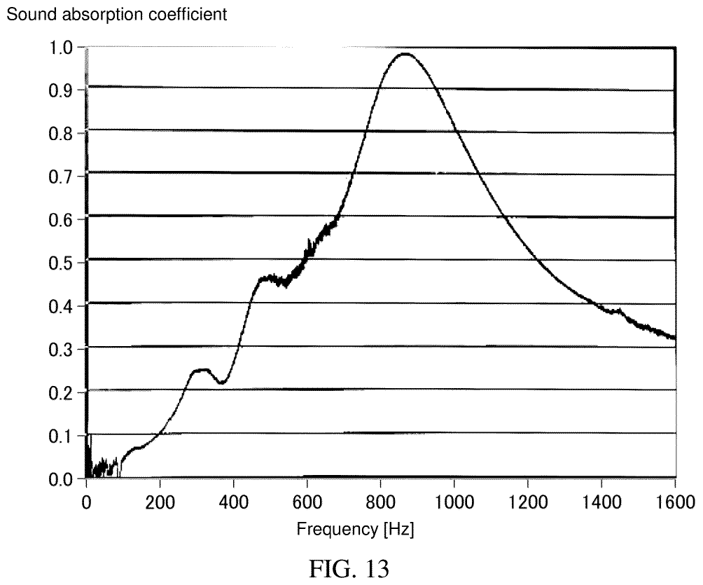

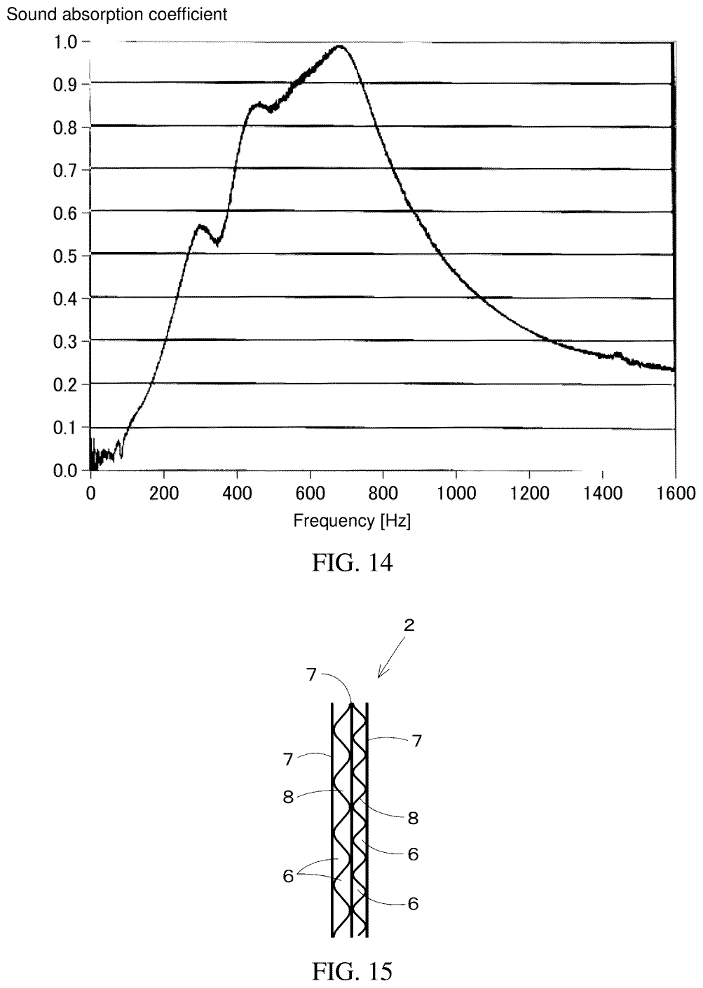

FIG. 13 and FIG. 14 are graphs of the results of measurements made during testing under conditions of normal incidence with the second test piece. At FIG. 13, the backside air layer was made to be 30 mm, and the representative frequency was 600 Hz. At FIG. 14, the backside air layer was made to be 50 mm, and the representative frequency was 700 Hz.

FIG. 15 through FIG. 17 pertain to a third test piece. Because the front view of the third test piece would be the same as that which is shown in FIG. 8, it is not shown. The sectional view thereof is that which is shown in FIG. 15, ordinary corrugated board in the form of the “multi-double-face corrugated board” which is shown at (c) in FIG. 3 having been used. Thickness of front face portion 2 was 3 mm+1.5 mm.

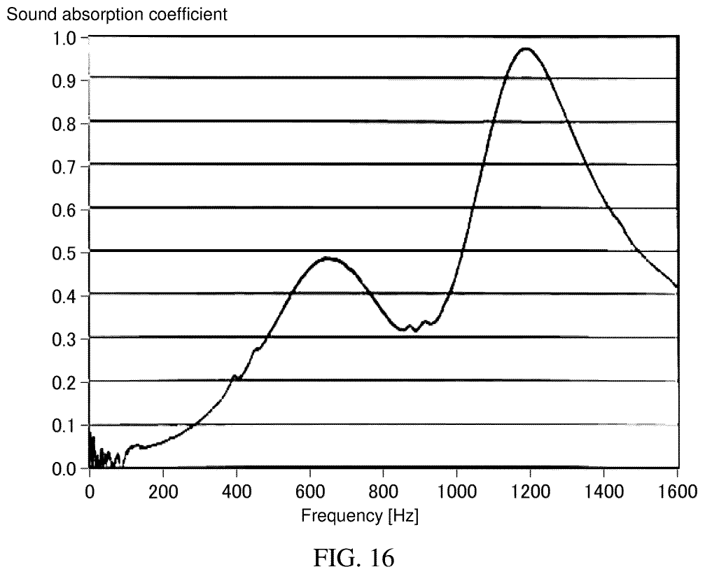

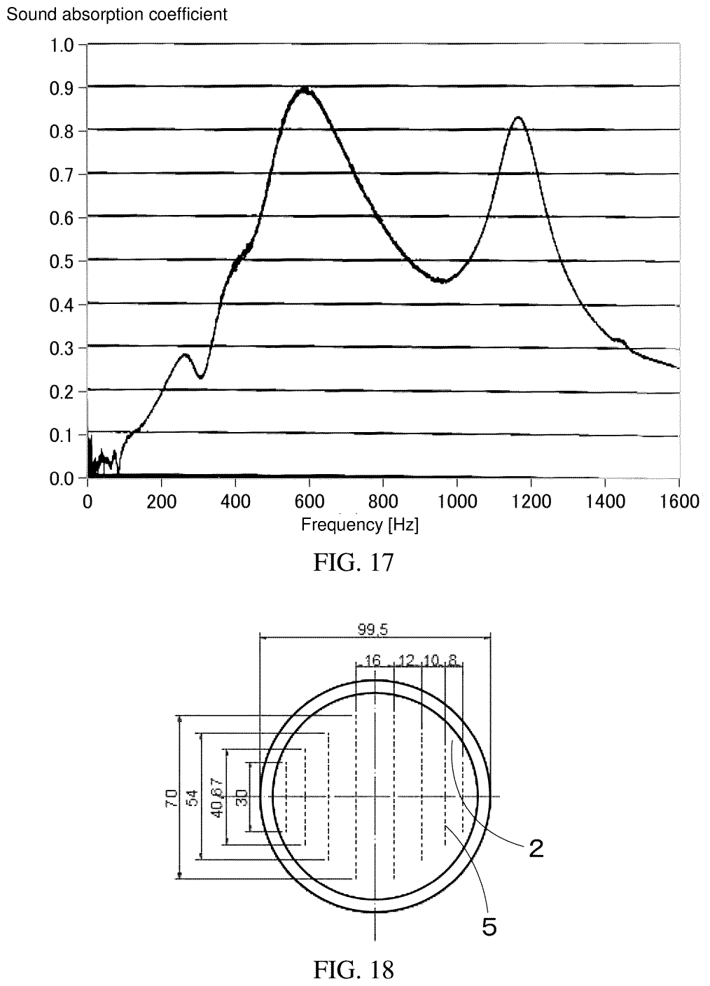

FIG. 16 is a graph of results of measurements made during testing performed under conditions of normal incidence when the backside air layer was made to be 15 mm, the representative frequency being 1200 Hz. FIG. 17 is a graph of results of measurements made during testing performed under conditions of normal incidence when the backside air layer was made to be 30 mm, the representative frequency being 600 Hz.

FIG. 18 through FIG. 20 pertain to a fourth test piece. A front view of the fourth test piece is shown in FIG. 18, the spacing of the slits 5 shown in the drawing being different from that which is shown in FIG. 8. Because the sectional view thereof would be the same as that shown in FIG. 15, it is not shown.

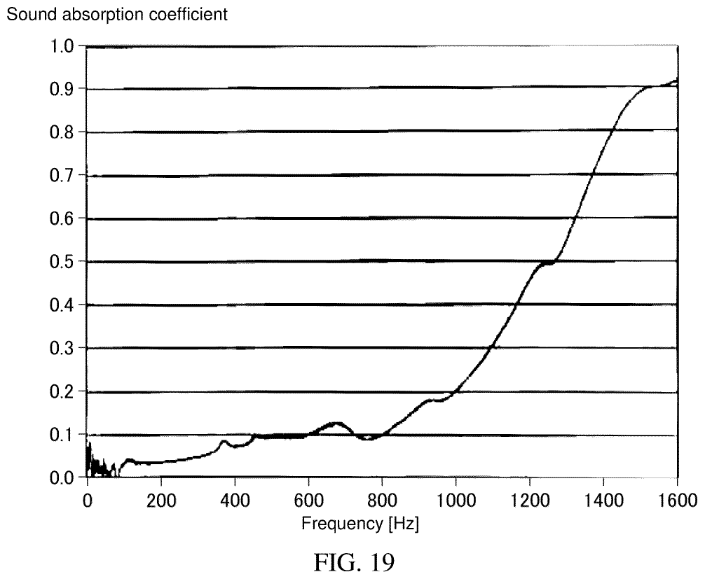

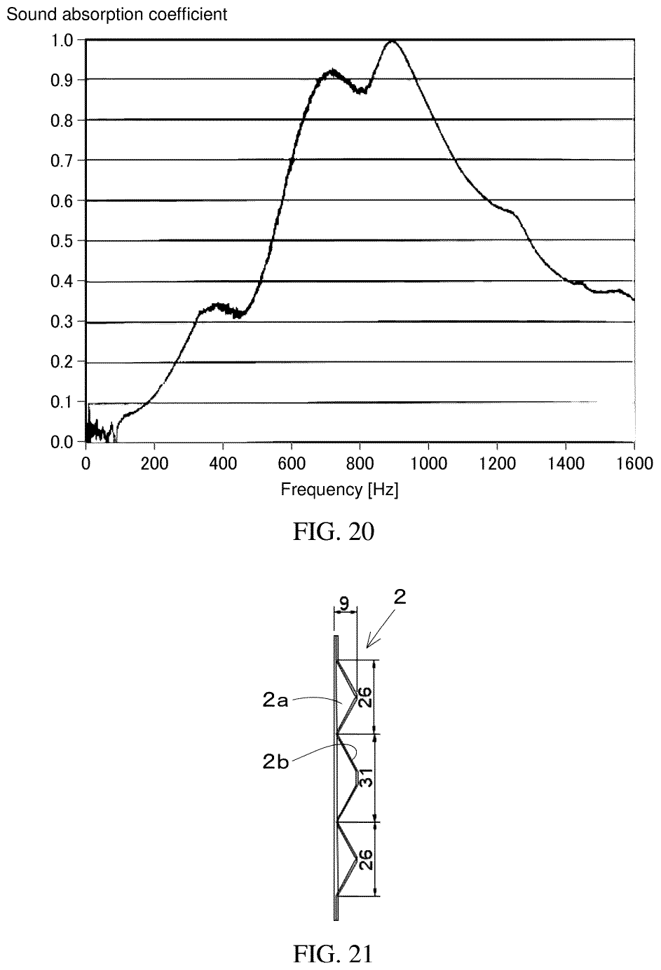

FIG. 19 is a graph of results of measurements made during testing performed under conditions of normal incidence when the backside air layer was made to be 10 mm, the representative frequency being 1600 Hz. FIG. 20 is a graph of results of measurements made during testing performed under conditions of normal incidence when the backside air layer was made to be 30 mm, the representative frequency being 900 Hz.

FIG. 21 through FIG. 23 pertain to a fifth test piece. Because the front view of the fifth test piece would be the same as that which is shown in FIG. 8, it is not shown. A cross-section thereof is shown in FIG. 21 and corresponds to (a) at FIG. 4. The cross-sectional shape of front face portion 2 was such that vented chamber 6 was formed by front face aluminum plate 2a of thickness 0.8 mm and corrugating aluminum angle plate 2b of thickness 0.5 mm, the thickness of front face portion 2 being 9 mm.

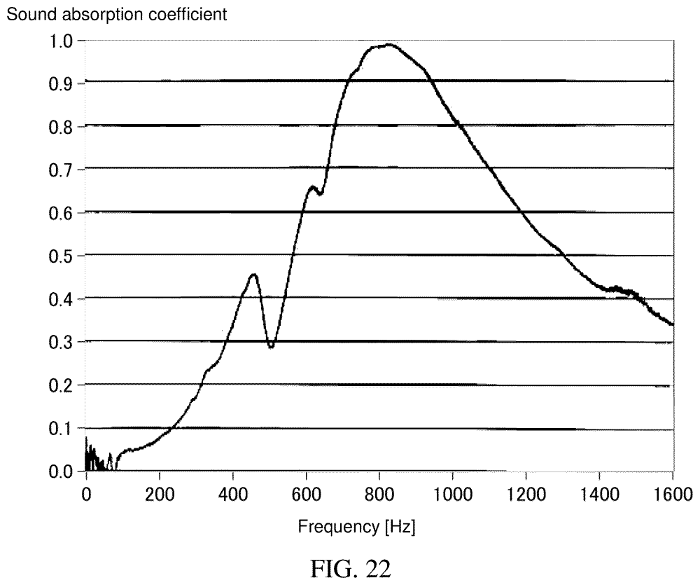

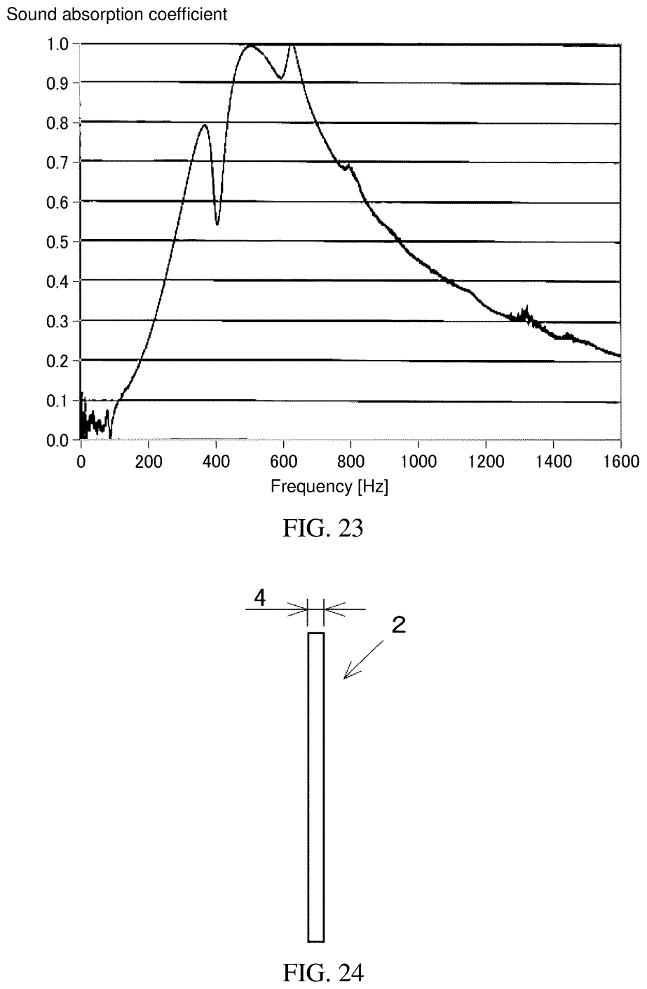

FIG. 22 is a graph of results of measurements made during testing performed under conditions of normal incidence when the backside air layer was made to be 30 mm, the representative frequency being 850 Hz. FIG. 23 is a graph of results of measurements made during testing performed under conditions of normal incidence when the backside air layer was made to be 50 mm, the representative frequency being 600 Hz.

FIG. 24 through FIG. 26 pertain to a sixth test piece. Because the front view of the sixth test piece would be the same as that which is shown in FIG. 8, it is not shown. A sectional view thereof is shown in FIG. 24 and corresponds to (d) at FIG. 4. The cross-sectional shape of front face portion 2 was such that vented chamber 6 was formed by front face aluminum plate 2a of thickness 0.8 mm, with respect to which a back face aluminum plate of thickness 0.5 mm was arranged so as to be parallel and separated therefrom by a prescribed space, the thickness of front face portion 2 being 4 mm.

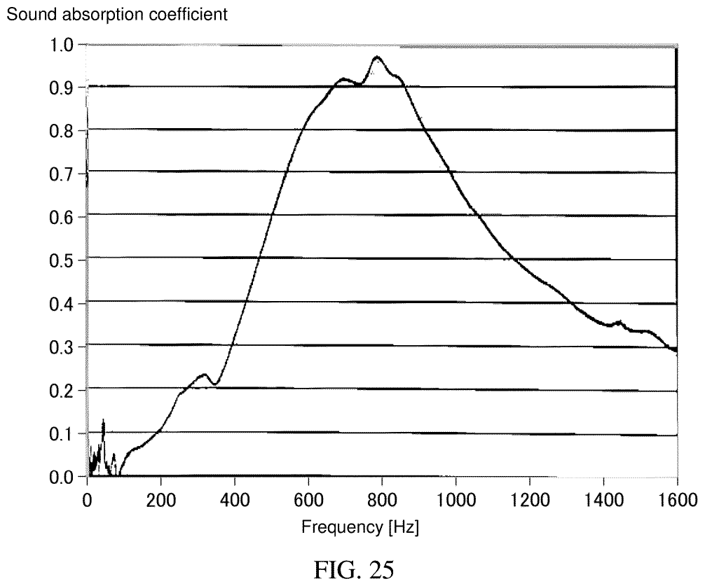

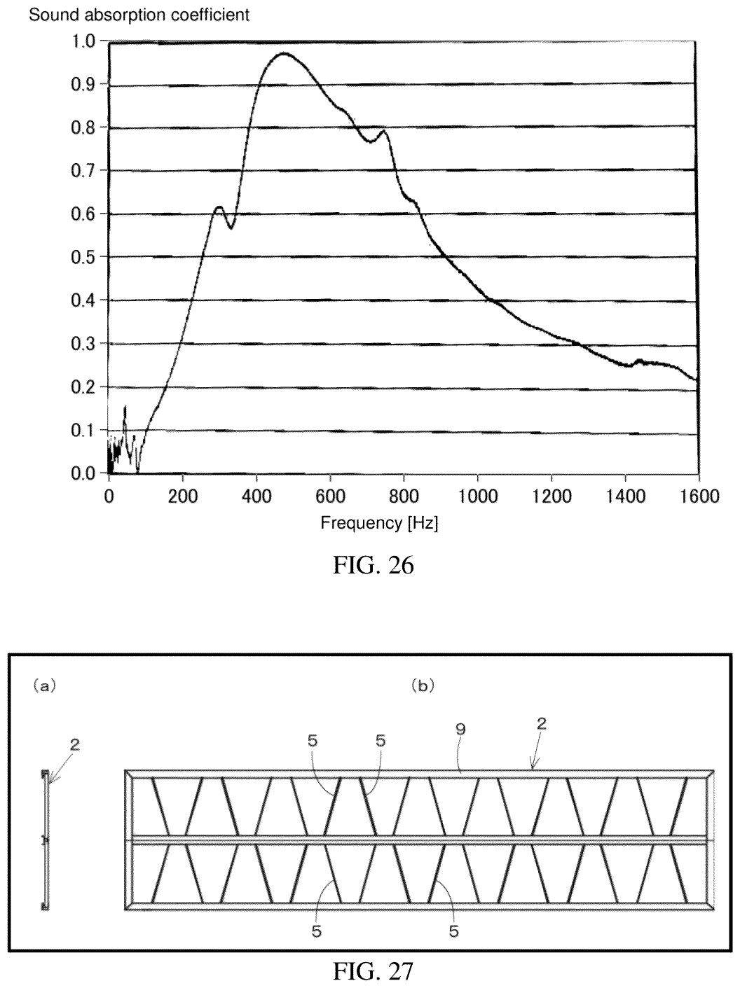

FIG. 25 is a graph of results of measurements made during testing performed under conditions of normal incidence when the backside air layer was made to be 30 mm, the representative frequency being 800 Hz. FIG. 26 is a graph of results of measurements made during testing performed under conditions of normal incidence when the backside air layer was made to be 50 mm, the representative frequency being 500 Hz.

Based on the foregoing experimental results, it can be understood that it was possible to achieve reduction in the thickness of sound-absorbing member 1.

FIG. 27 through FIG. 29 show front face portion 2 such as may be used in a sound-absorbing member for indoor use which may be used at sites not subject to wind load such as that which might be used in interior walls for indoor corridors, machine room interior wall soundproofing, and so forth.

At FIG. 27, front face portion 2 is such that two flat plates are arranged in parallel for a thickness of 4 mm, being retained by form 9, the region between the two flat plates constituting vented chamber(s) 6. Slits 5 are provided at this front face portion 2.

That which is shown in FIG. 28 is such that front face portion 2 is constituted from “double-face corrugated board.” Piece 10 shown at (b) in same drawing engages with and is secured to form 9 by way of intervening slit(s) 5 as shown at (a) in same drawing. That is, gap(s) between piece(s) 10 and piece(s) 10 constitute slit(s) 5.

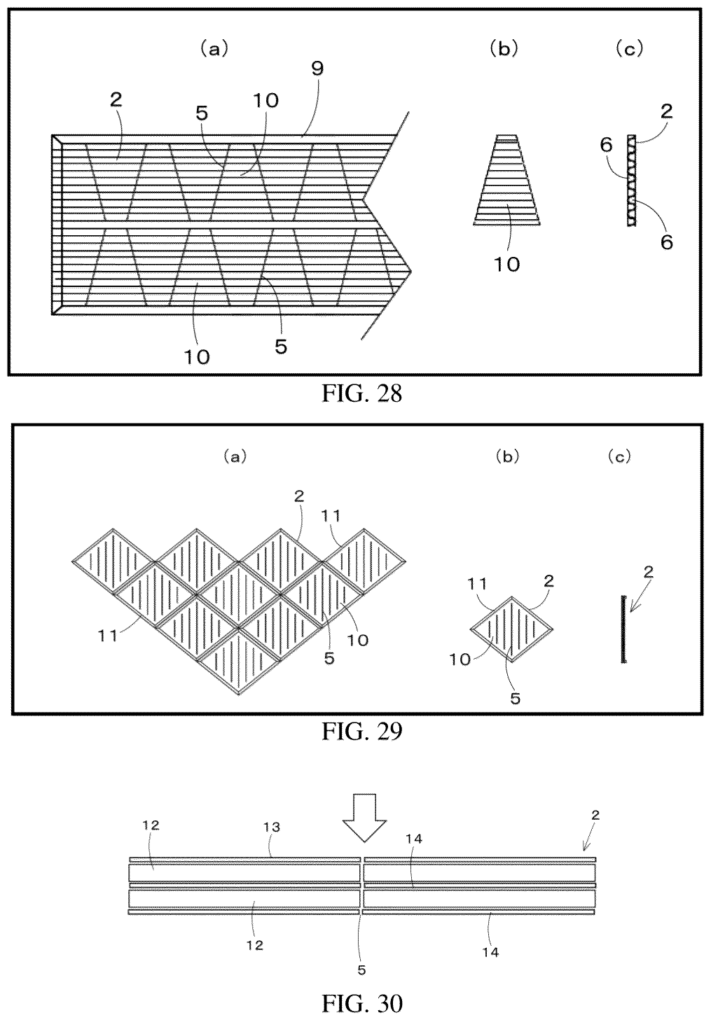

That which is shown in FIG. 29 is such that front face portion 2 is constituted from corrugated board, piece 10 shown at (b) in same drawing being secured to rim edging material 11. A plurality of slits 5 are formed at this piece 10.

FIG. 30 shows a situation in which sound-absorbing material 12 is contained within vented chamber 6. Front face portion 2 has surface material 13 and a plurality of linerboards 14, the regions between surface material 13 and linerboard 14, and between linerboard 14 and linerboard 14, constituting vented chamber(s) 6, sound-absorbing material 12 being contained within vented chamber(s) 6. Provided at this front face portion 2 are slits 5 that extend all the way therethrough in the thickness direction.

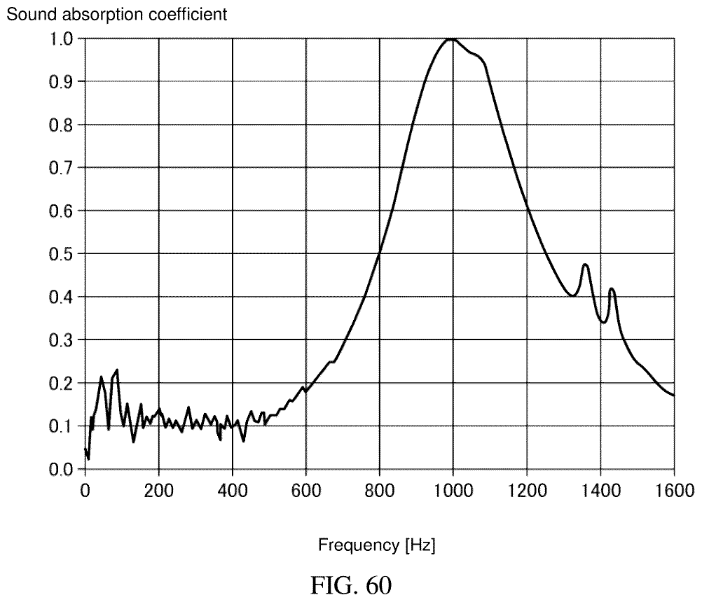

A slate plate, asbestos cement plate, or the like may be employed as surface material 13. Transparent sheeting (polycarbonate) or plywood or thin board in the form of cypress, cedar, or other such material or the like may be employed as linerboard 14. Nonwoven polyester fabric, glass wool, open-cell foamed plastic (EPDM and/or urethane), and/or the like may be employed as sound-absorbing material 12. Expanded metal may be employed as sound-absorbing material 12.

Whereas slits 5 were described by way of example as being linear at the foregoing embodiments, they may be wavelike, arcuate, or of other shape. Slit(s) may depict a graphical shape or the like so as to increase decorativeness. Where decorativeness is to be increased, vented chamber(s) should be surface-like rather than hole-like (see (d) at FIG. 4). While laser processing is suitably employed for formation of slits, it is also possible to employ other processing method(s) for formation thereof. Slits may be formed using the “yotsume pattern structure” shown in “FIG. 60” and elsewhere at “Japanese Patent Application No. 2022-50983” associated with the present inventor(s).

FIG. 31 and thereafter show other embodiments of the present invention. FIG. 31 shows planar aluminum plate 2e of thickness 0.5 mm. Aluminum plate 2c is formed so as to be rectangular such that the long sides thereof are in the X direction and the short sides thereof are in the Y direction. At this aluminum plate 2c, slits 5 which extend all the way therethrough in the thickness direction have prescribed length(s) in the X direction, a plurality thereof being formed so as to lie along straight line(s) at prescribed spacing(s) in the X direction. Two rows of these slits 5 are provided such that there is a prescribed spacing therebetween in the Y direction. While it is preferred that slits 5 be formed by laser processing, they may also be formed by punching by means of a press and/or by machining.

It is preferred that width of slits 5 in the Y direction be not greater than 2 mm. While length of slits 5 in the X direction will vary depending on board thickness. this might be on the order of 30 mm to 50 mm. Slits 5 should be arranged such that there is a spacing therebetween of 50 mm to 70 mm in the X direction. Fractional area comprised by the openings of slits 5 is not greater than 5%.

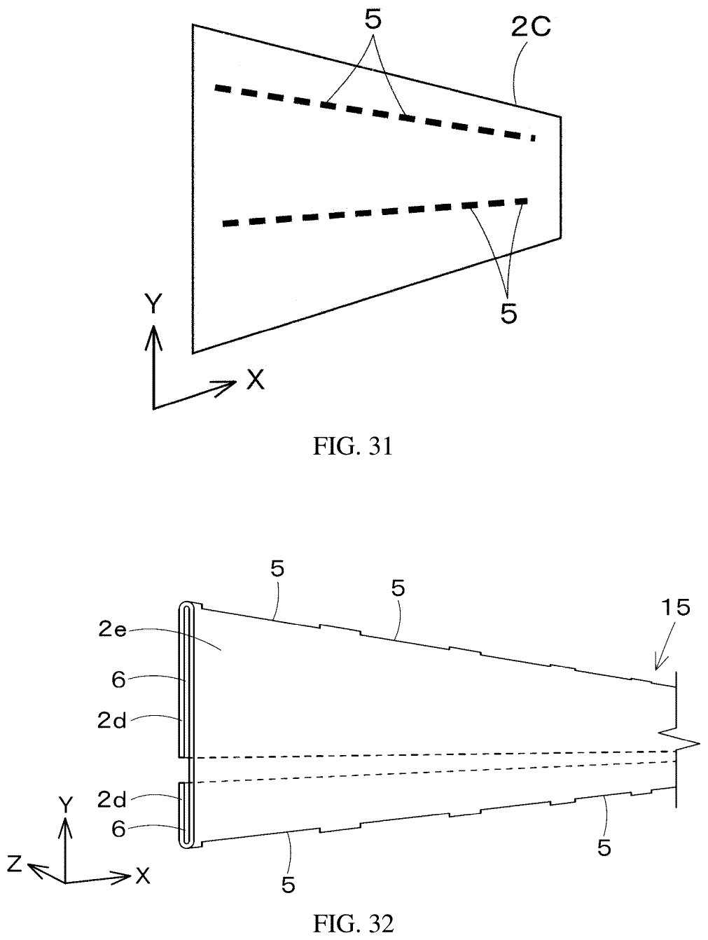

As shown in FIG. 32, the top and bottom ends of rectangular aluminum plate 2c are both folded back upon themselves by 180 degrees in the same direction at the locations of the foregoing slits 5 to form folded portions 2d. Vented chamber 6 of prescribed thickness in the Z direction is formed in the space between this folded portion 2d and planar portion 2e between slits 5. Thickness of vented chamber 6 should not be greater than 0.5 mm to 10 mm or the width of the foregoing slit 5. Thickness of vented chamber 6 in the Z direction need not be constant. That is, folded portion 2d and planar portion 2e need not be parallel. The distance from the crease of the fold to the end of the folded portion may vary in splayed fashion from 0.2 mm to 8 mm.

That which is formed by such folding is hereinafter referred to as “front face piece 15.”

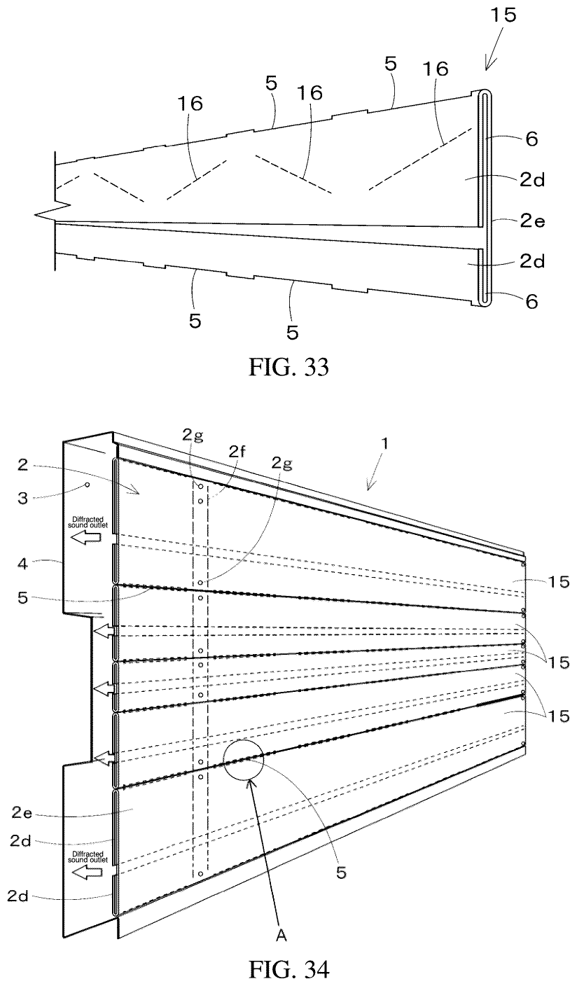

As shown in FIG. 33, additional slits 16 may be formed by laser processing at folded portion 2d. Note that these additional slits 16 may be formed in planar aluminum plate 2c shown in FIG. 31. While additional slits 16 are provided so as to be inclined with respect to the X direction, there is no limitation with respect thereto, it being possible for these to be perpendicular to the X direction or parallel thereto. Lengths of additional slits 16 are not greater than 50 mm, and it is possible to arrange multiple varieties thereof which are of differing lengths and angles of inclination.

As shown in FIG. 34, a plurality of the foregoing front face pieces 15 are arranged so as to lie in the X-Y plane and make up multiple segments in intimate contact in the Y direction to constitute front face portion 2. Back face portion 4 is arranged at this front face portion 2 such that backside air layer 3 intervenes therebetween to constitute sound-absorbing member 1.

This vertical plurality of front face pieces 15 are coupled to and secured by securing rivets 2g to support frame 2f which is arranged in the vertical direction within backside air layer 3.

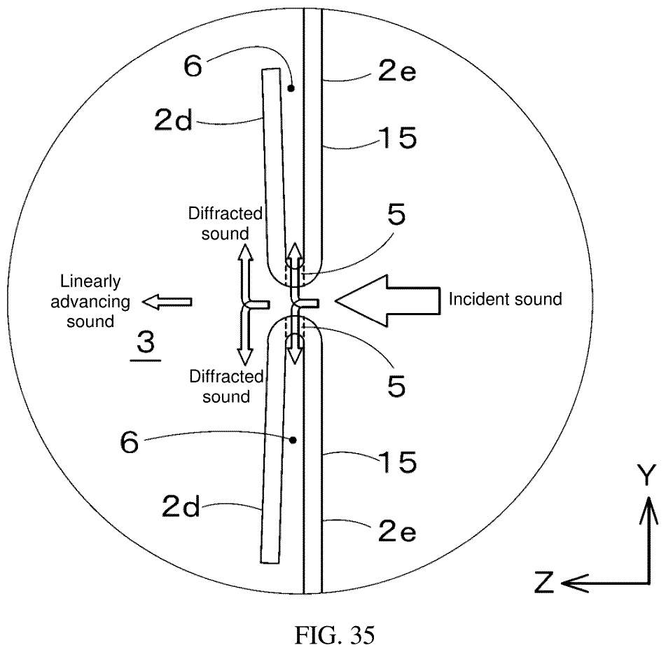

FIG. 35 is an enlarged sectional view of a location at slits 5 where upper and lower front face pieces 15, 15 of front face portion 2 are connected. As shown in same drawing, at slit 5 at folded portion 2d, when the incident sound advances linearly toward backside air layer 3, it is diffracted toward vented chamber 6, and the diffracted sound advances linearly from slit 5 to vented chamber 6.

The locations of slits 5 of respective upper and lower front face pieces 15 which are in intimate contact in the Y direction are aligned in the X direction. In addition, the gap in the Y direction at the location where slits 5 of upper and lower front face pieces 15 which are in intimate contact does not exceed 3 mm. That is, the gap through which the incident sound advances linearly at FIG. 35 is not greater than 3 mm. The sound which advances linearly from this gap is diffracted from slit 5 and advances linearly to vented chamber 6.

The structure of vented chamber 6 is such as will not constitute a barrier to the sound that is diffracted from slit 5.

Vented chamber 6 has an inlet from slit 5 and has an outlet that communicates with backside air layer 3 from the end of the folded portion, it being necessary that this not be a closed space. Moreover, at additional slits 16 as well, the constitution is such that there are outlets which communicate with backside air layer 3.

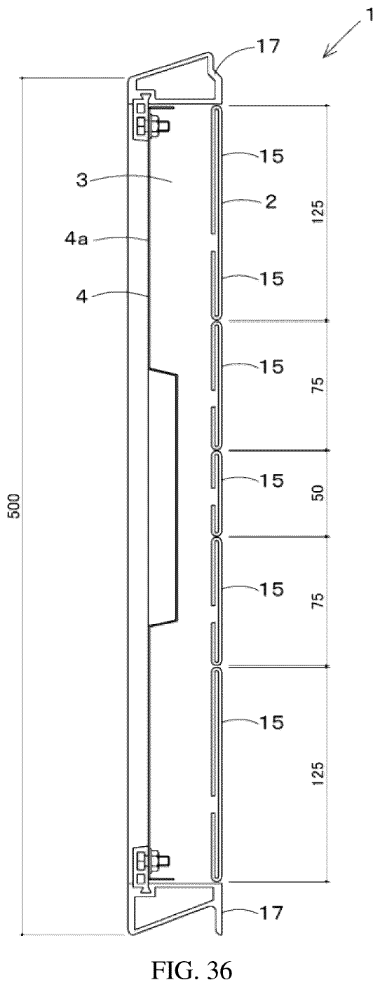

As shown in FIG. 36, front face portion 2 which is made up of front face pieces 15 may be retained by aluminum frame 17. Back face panel 4a is retained by this aluminum frame 17, constituting back face portion 4. Dimensions in the Y direction of front face pieces 15 are, in order from the bottom to the top, 125 mm, 75 mm, 50 mm, 75 mm, and 125 mm.

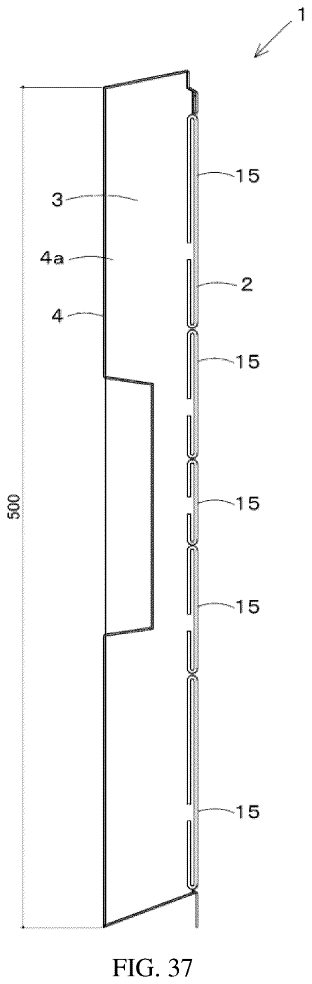

That which is shown in FIG. 37 is such that front face portion 2 which is made up of front face pieces 15 is retained by back face panel 4a. Back face panel 4a is made up of galvanized sheet iron. The structure of this back face panel 4a is more or less the same as that which is shown in FIG. 2.

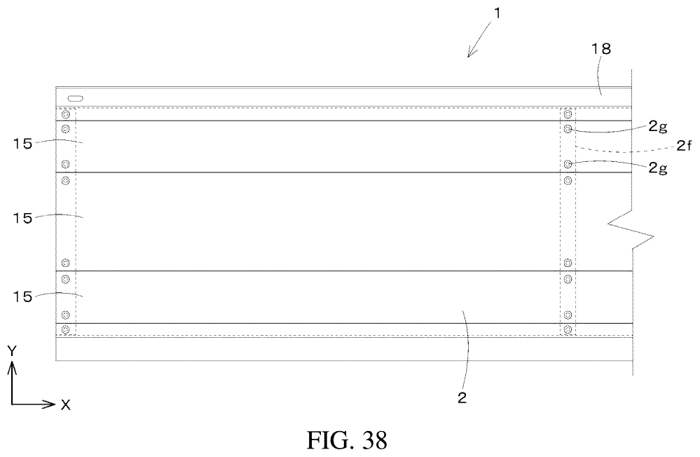

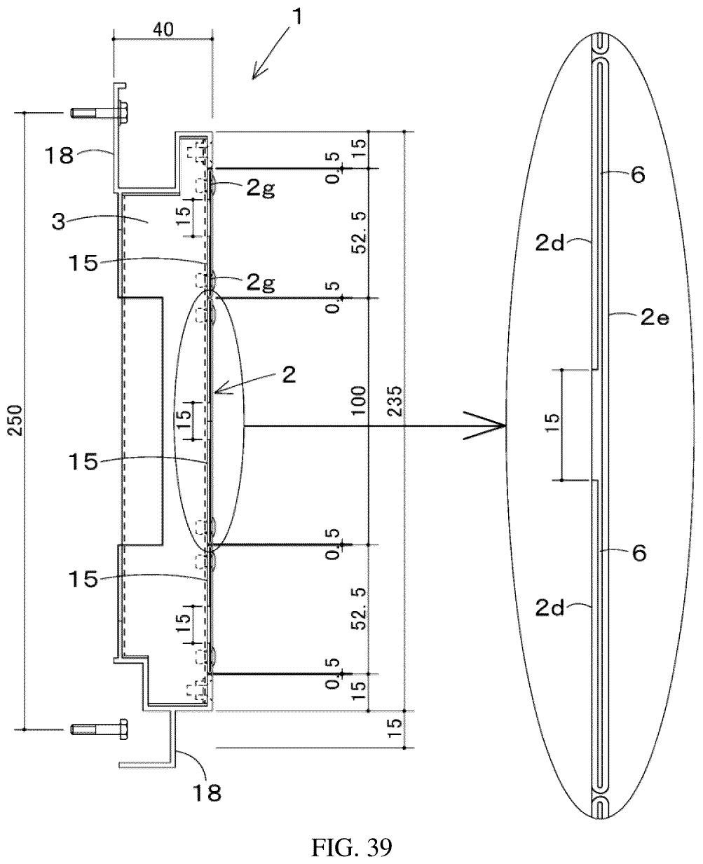

That which is shown in FIG. 38 and FIG. 39 is a spandrel-type object in which sound-absorbing member 1 in accordance with the present invention is employed as a ceiling or wall sound-absorbing device. Front face portion 2 which is made up of front face pieces 15 is retained by spandrel-type aluminum form 18 which is attached to a ceiling or wall. While back face portion 4 may be retained by this aluminum form 18, the ceiling or wall may itself be used as back face portion 4. Dimensions in the Y direction of front face pieces 15 are, in order from the bottom to the top, 52.5 mm, 100 mm, and 52.5 mm. The separation between ends of folded portions 2d of front face pieces 15 is 15 mm. Due to this separation, vented chamber 6 and backside air layer 3 are in communication.

This vertical plurality of front face pieces 15 are coupled to and secured by securing rivets 2g to support frame 2f which is arranged in the vertical direction within backside air layer 3.

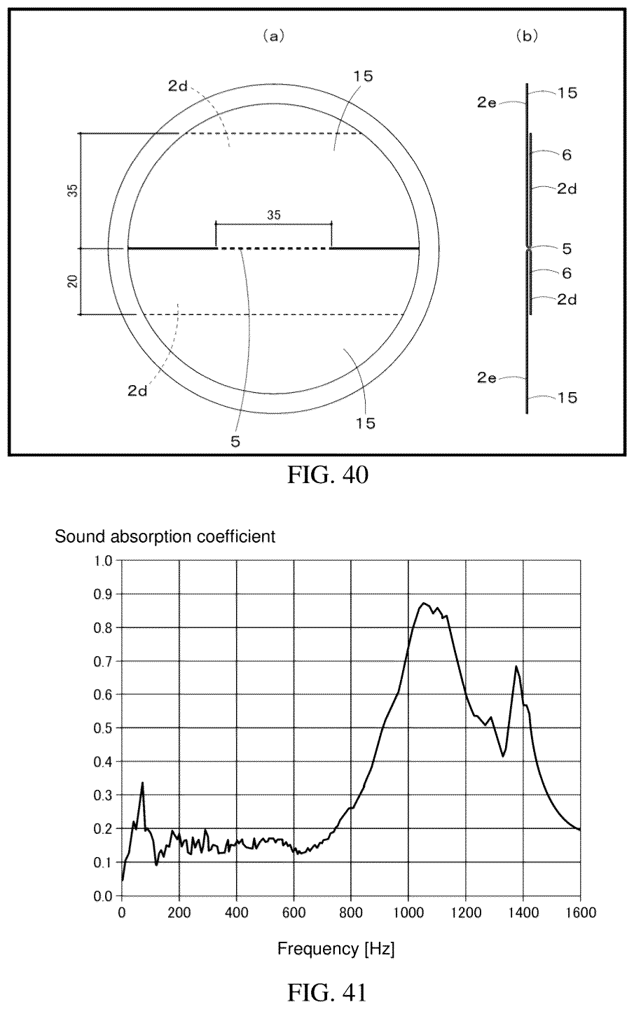

FIG. 40 through FIG. 42 pertain to a seventh test piece.

(a) at FIG. 40 is a front view of the seventh test piece; (b) at same drawing is a sectional view thereof.

The seventh test piece was such that the slit 5 with spacing 100 mm in the Y direction shown in FIG. 39 was arranged at the center of the test piece. Aluminum plate thickness was 0.5 mm; length of slit 5 in the X direction was 35 mm; lengths in the Y direction of folded portions 2d were 35 mm and 20 mm. Additional slits 16 were not formed at folded portions 2d.

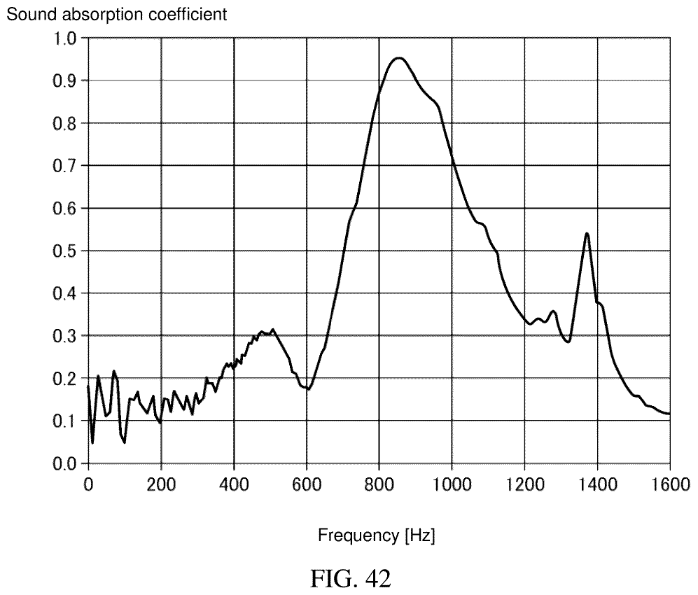

FIG. 41 is a graph of results of measurements made during testing performed under conditions of normal incidence when the backside air layer was made to be 20 mm, the representative frequency being 650 Hz. FIG. 42 is a graph of results of measurements made during testing performed under conditions of normal incidence when the backside air layer was made to be 40 mm, the representative frequency being 450 Hz.

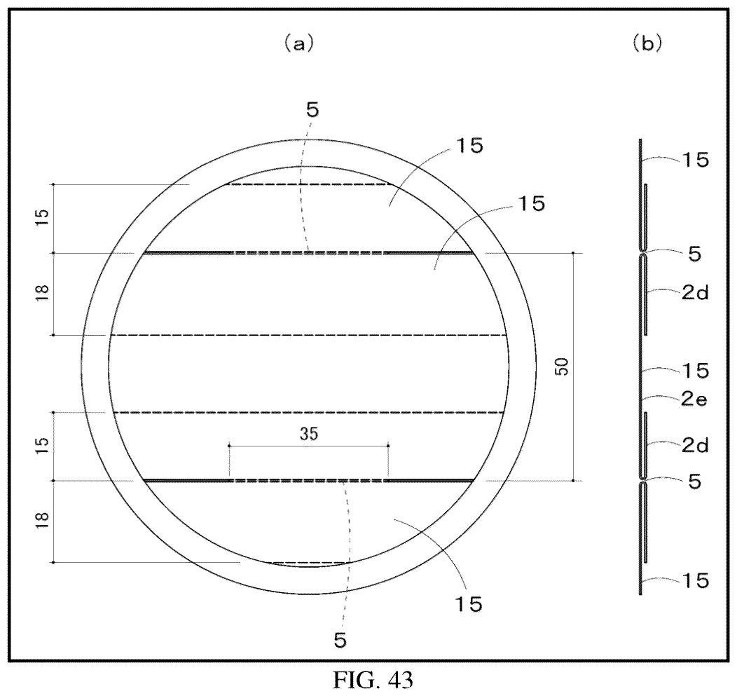

Based on the foregoing experimental results, it can be understood that it was possible to achieve reduction in the thickness of sound-absorbing member 1. FIG. 43 through FIG. 45 pertain to an eighth test piece.

(a) at FIG. 43 is a front view of the eighth test piece; (b) at same drawing is a sectional view thereof.

The eighth test piece was such that the slit 5 with spacing 50 mm in the Y direction shown in FIG. 36 was arranged at the center of the test piece. Aluminum plate thickness was 0.5 mm; length of slit 5 in the X direction was 35 mm; lengths in the Y direction of folded portions 2d were 15 mm and 18 mm. Additional slits 16 were not formed at folded portions 2d.

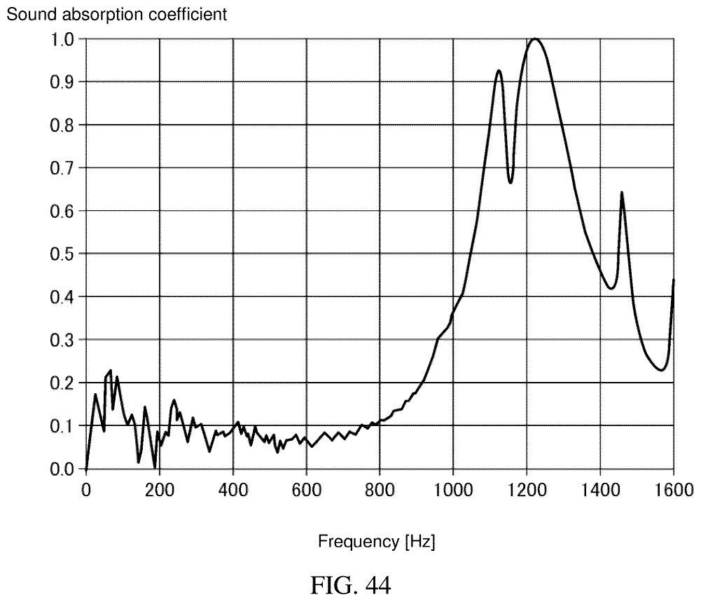

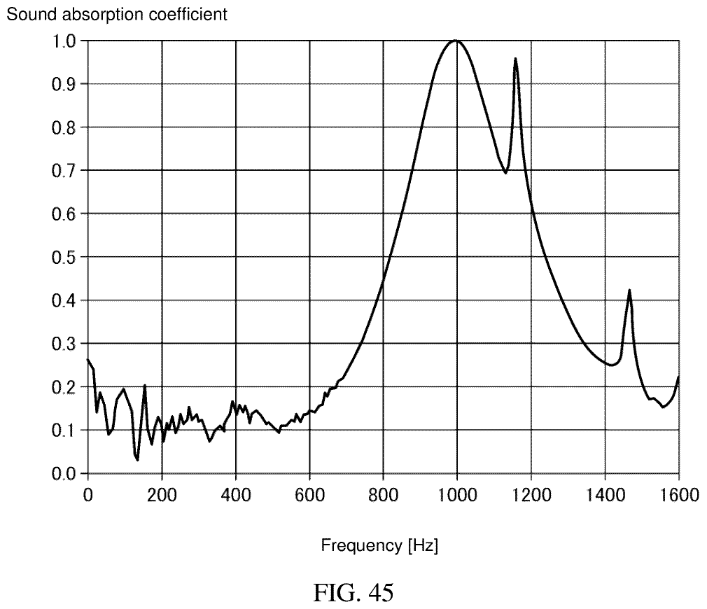

FIG. 44 is a graph of results of measurements made during testing performed under conditions of normal incidence when the backside air layer was made to be 20 mm, the representative frequency being 850 Hz. FIG. 45 is a graph of results of measurements made during testing performed under conditions of normal incidence when the backside air layer was made to be 40 mm, the representative frequency being 550 Hz.

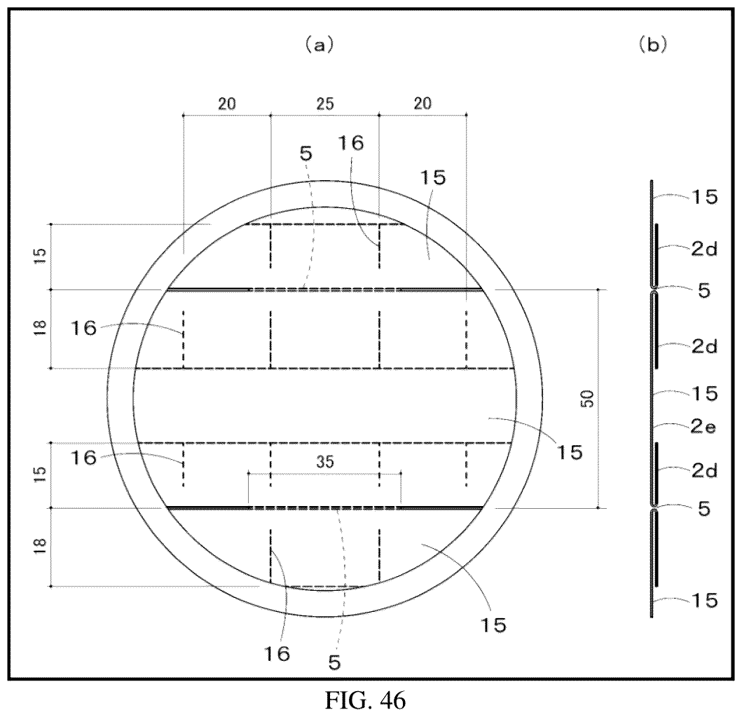

FIG. 46 through FIG. 48 pertain to a ninth test piece.

(a) at FIG. 46 is a front view of the ninth test piece; (b) at same drawing is a sectional view thereof.

The ninth test piece was the same as that shown in FIG. 43, but additional slits 16 were formed at folded portion 2d. The spacings in the X direction at which additional slits 16 were formed thereat were 20 mm, 25 mm, and 20 mm, these being provided so as to be perpendicular to the X direction.

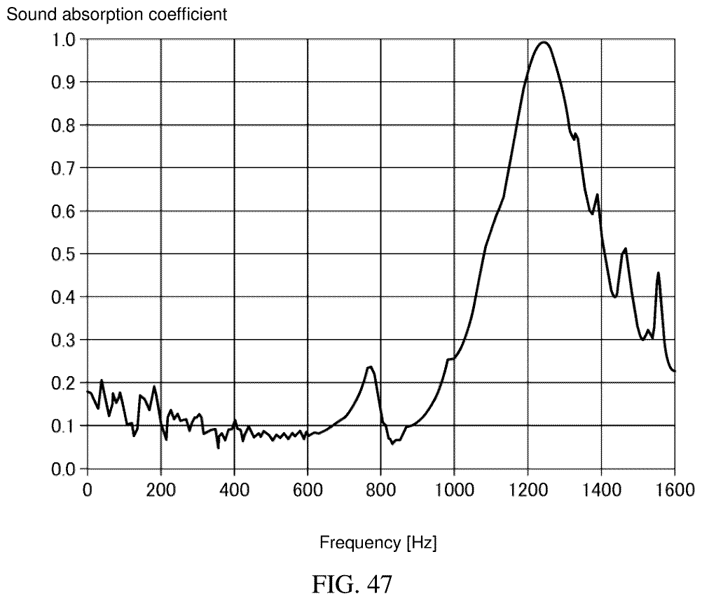

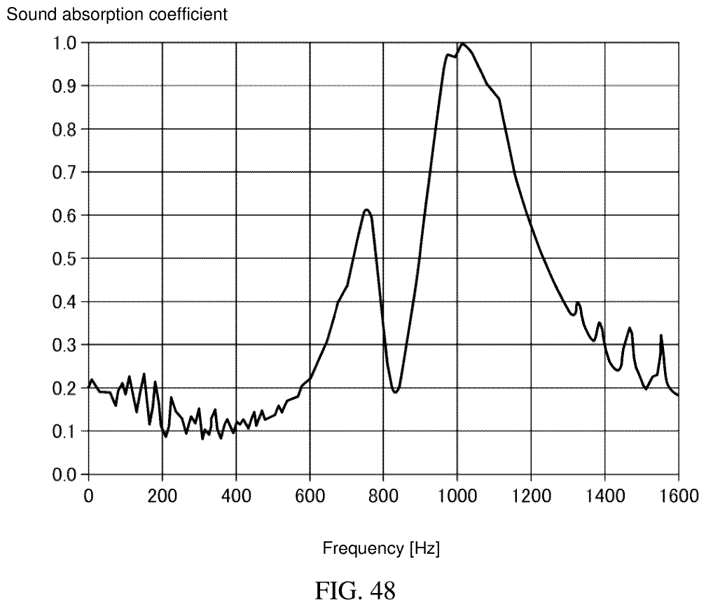

FIG. 47 is a graph of results of measurements made during testing performed under conditions of normal incidence when the backside air layer was made to be 20 mm, the representative frequency being 800 Hz. FIG. 48 is a graph of results of measurements made during testing performed under conditions of normal incidence when the backside air layer was made to be 40 mm, the representative frequency being 600 Hz.

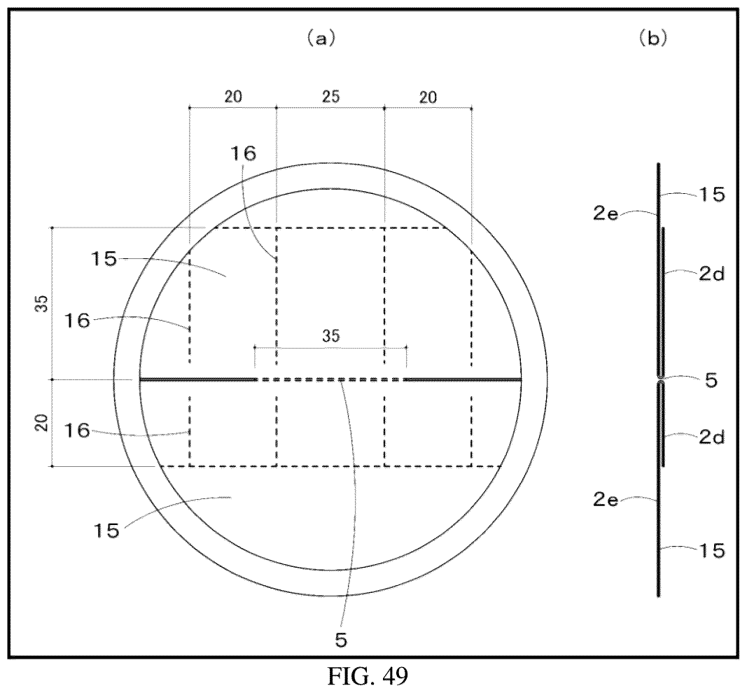

FIG. 49 through FIG. 51 pertain to a tenth test piece.

(a) at FIG. 49 is a front view of the tenth test piece; (b) at same drawing is a sectional view thereof.

The tenth test piece was of the same shape as that shown in FIG. 40, but it was made up of galvanized iron sheeting of thickness 0.27 mm, and additional slits 16 were formed at folded portion 2d. The spacings in the X direction at which additional slits 16 were formed thereat were 20 mm, 25 mm, and 20 mm, these being provided so as to be perpendicular to the X direction.

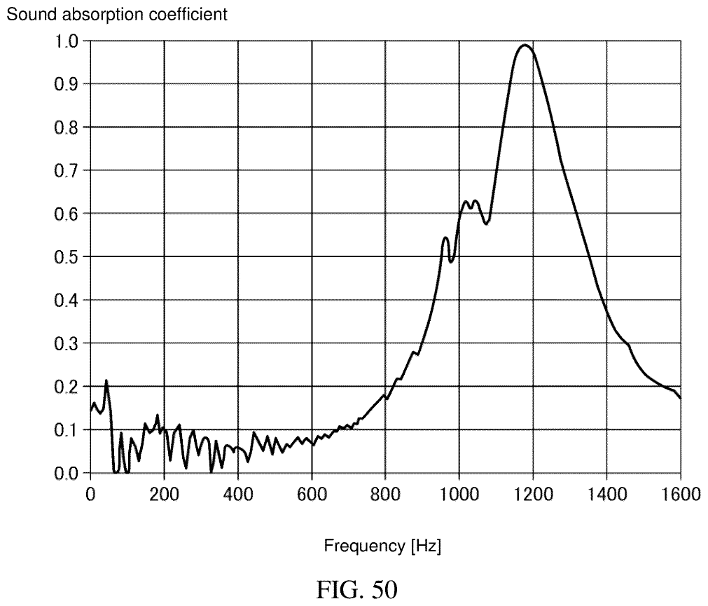

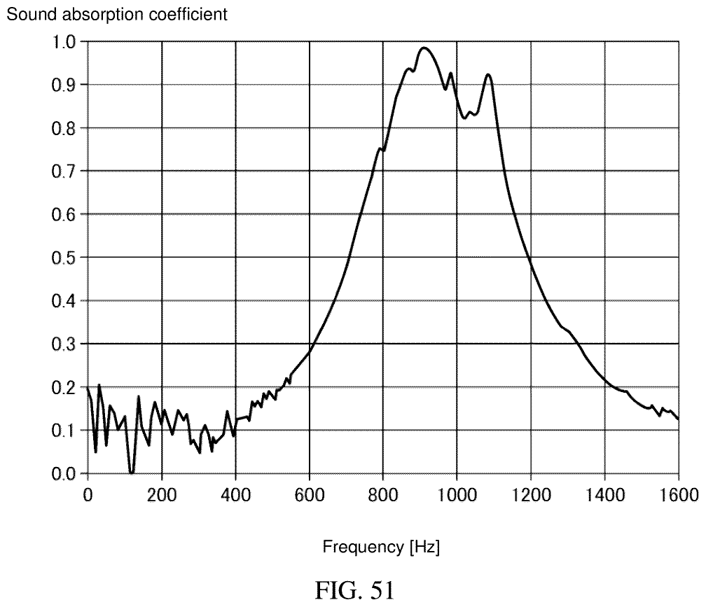

FIG. 50 is a graph of results of measurements made during testing performed under conditions of normal incidence when the backside air layer was made to be 20 mm, the representative frequency being 750 Hz. FIG. 51 is a graph of results of measurements made during testing performed under conditions of normal incidence when the backside air layer was made to be 40 mm, the representative frequency being 500 Hz.

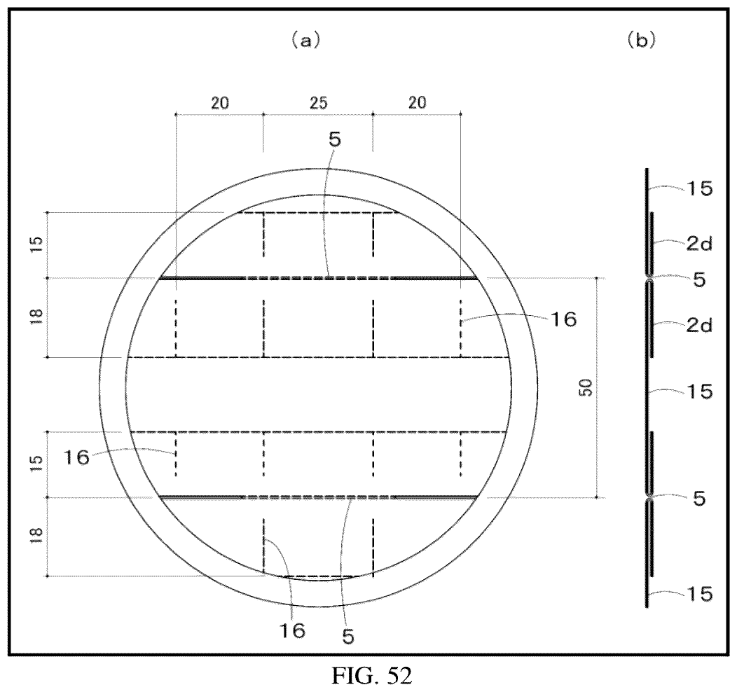

FIG. 52 through FIG. 54 pertain to an eleventh test piece.

(a) at FIG. 52 is a front view of the eleventh test piece: (b) at same drawing is a sectional view thereof.

The eleventh test piece was of the same shape as that shown in FIG. 46, but it was made up of galvanized iron sheeting of thickness 0.27 mm, and additional slits 16 were formed at folded portion 2d. The spacings in the X direction at which additional slits 16 were formed thereat were 20 mm, 25 mm, and 20 mm, these being provided so as to be perpendicular to the X direction.

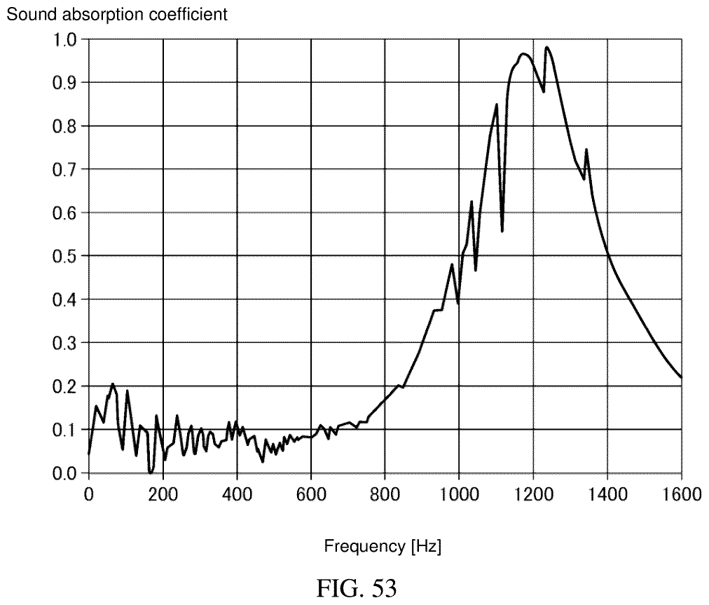

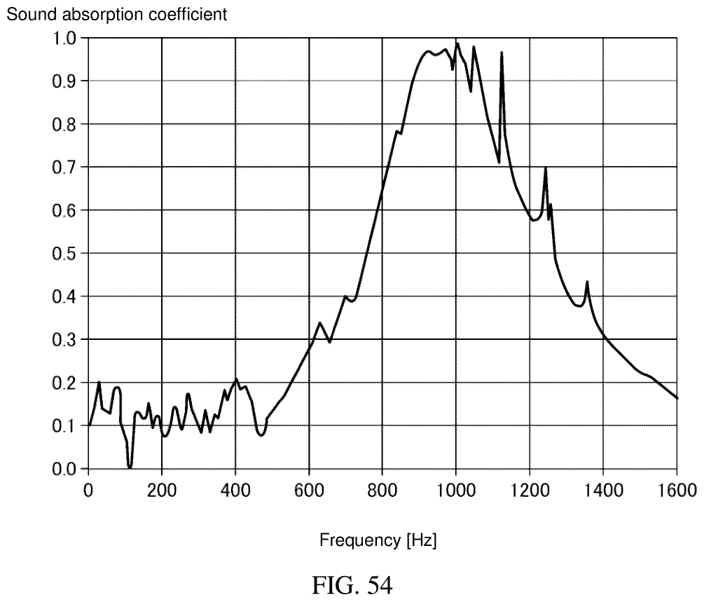

FIG. 53 is a graph of results of measurements made during testing performed under conditions of normal incidence when the backside air layer was made to be 20 mm, the representative frequency being 750 Hz. FIG. 54 is a graph of results of measurements made during testing performed under conditions of normal incidence when the backside air layer was made to be 40 mm, the representative frequency being 500 Hz.

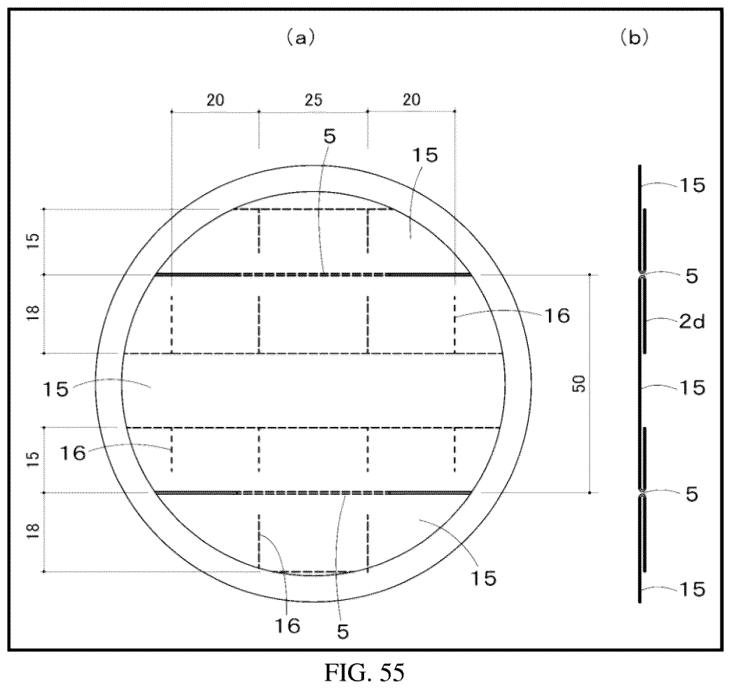

FIG. 55 through FIG. 57 pertain to a twelfth test piece.

(a) at FIG. 55 is a front view of the twelfth test piece; (b) at same drawing is a sectional view thereof.

The twelfth test piece was of the same shape as that shown in FIG. 52, but it was made up of stainless steel of thickness 0.2 mm.

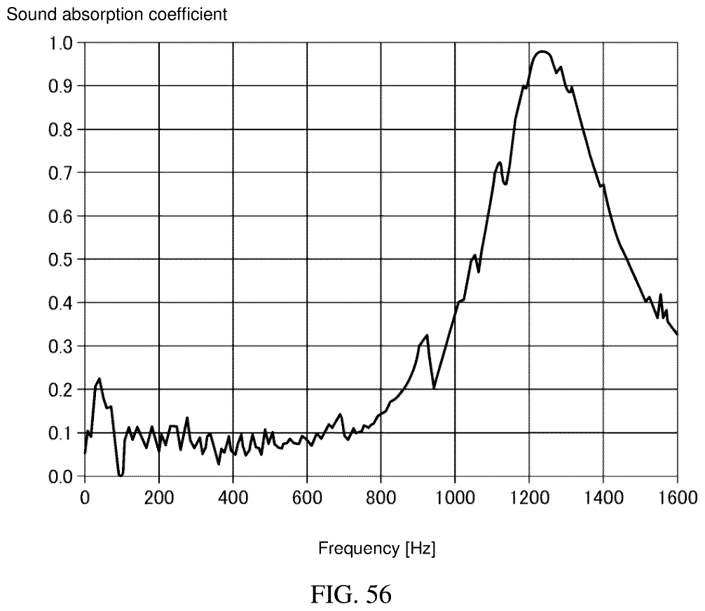

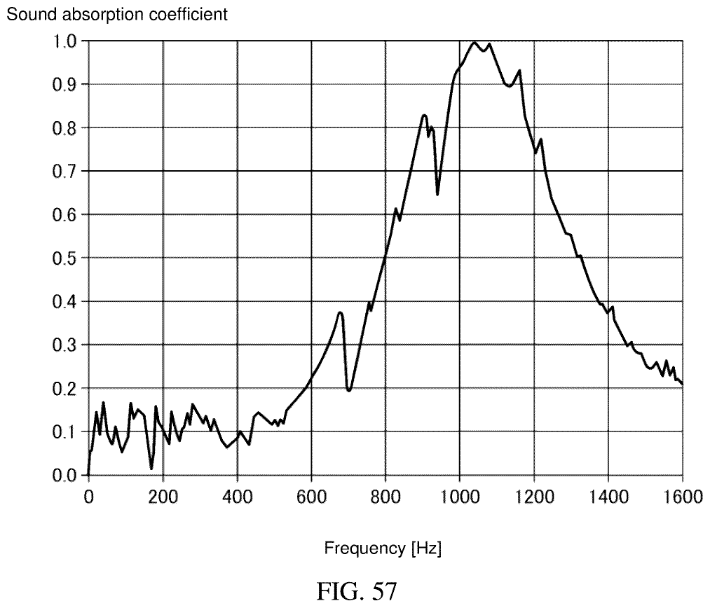

FIG. 56 is a graph of results of measurements made during testing performed under conditions of normal incidence when the backside air layer was made to be 20 mm, the representative frequency being 850 Hz. FIG. 57 is a graph of results of measurements made during testing performed under conditions of normal incidence when the backside air layer was made to be 40 mm, the representative frequency being 600 Hz.

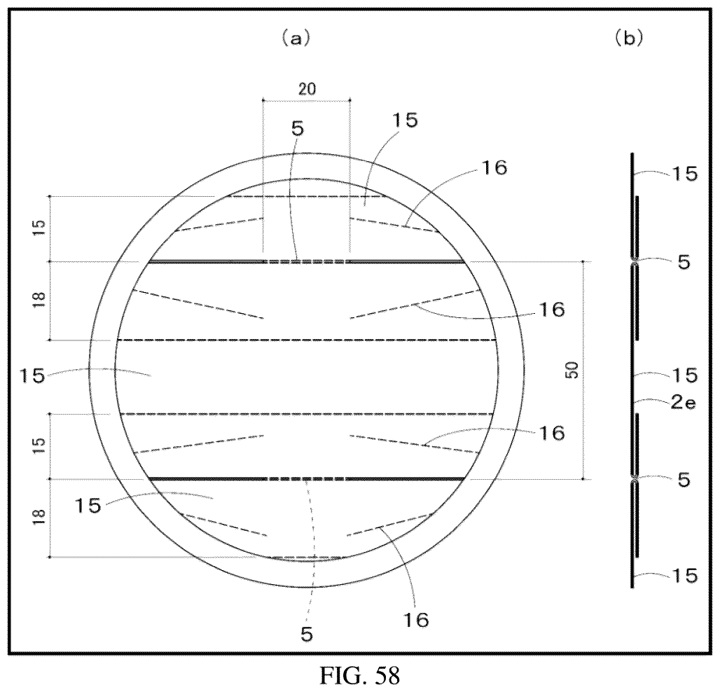

FIG. 58 through FIG. 60 pertain to a thirteenth test piece.

(a) at FIG. 58 is a front view of the thirteenth test piece; (b) at same drawing is a sectional view thereof.

The thirteenth test piece was of the same shape as that shown in FIG. 55, but it was made up of aluminum of thickness 0.5 mm, and additional slits 16 were provided at folded portion 2d so as to be inclined with respect to the X direction.

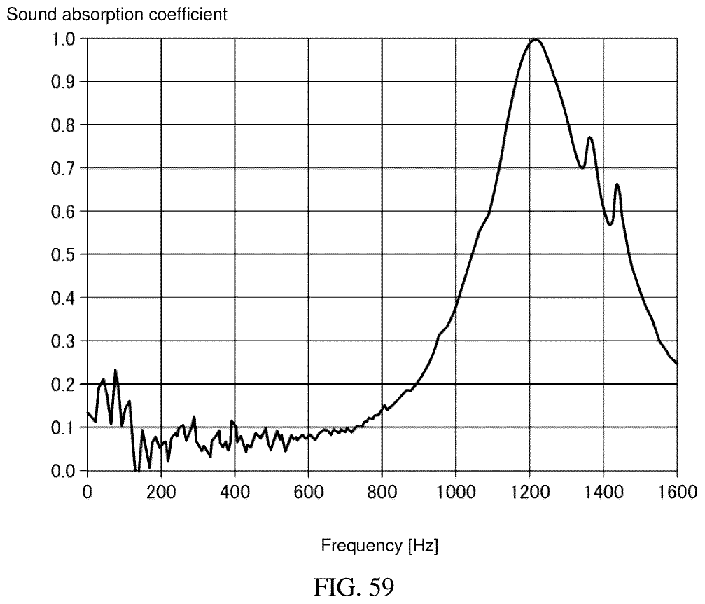

FIG. 59 is a graph of results of measurements made during testing performed under conditions of normal incidence when the backside air layer was made to be 20 mm, the representative frequency being 800 Hz. FIG. 60 is a graph of results of measurements made during testing performed under conditions of normal incidence when the backside air layer was made to be 40 mm, the representative frequency being 600 Hz.

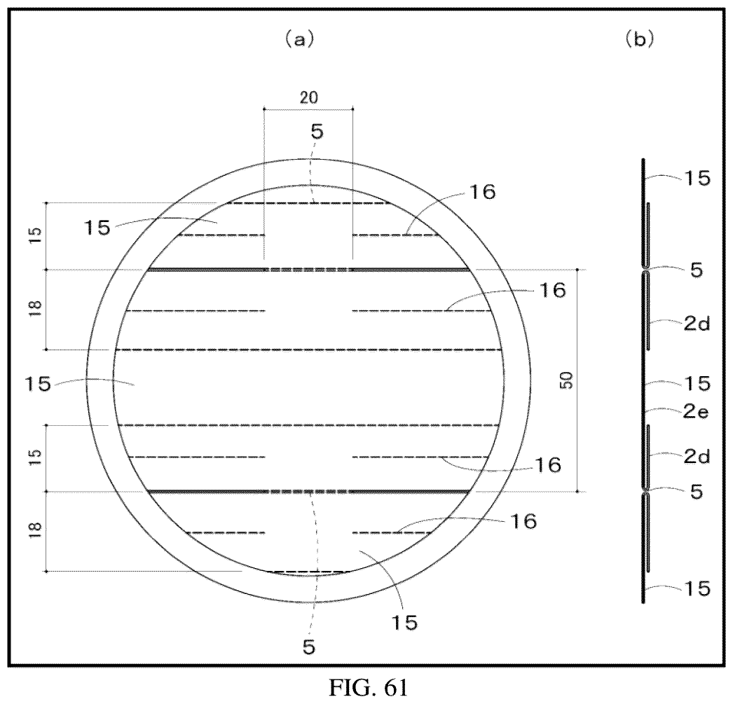

FIG. 61 through FIG. 63 pertain to a fourteenth test piece.

(a) at FIG. 61 is a front view of the fourteenth test piece; (b) at same drawing is a sectional view thereof.

The fourteenth test piece was of the same shape as that shown in FIG. 58, but differed therefrom in that additional slits 16 were provided at folded portion 2d so as to be parallel to the X direction.

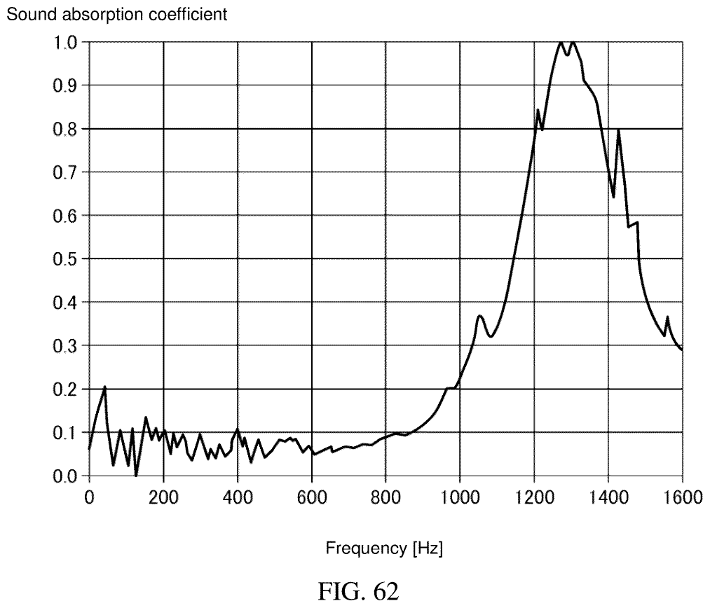

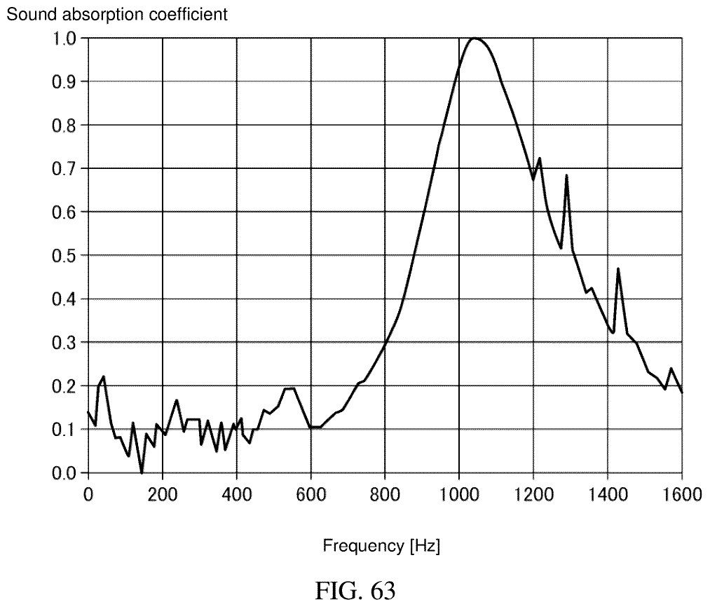

FIG. 62 is a graph of results of measurements made during testing performed under conditions of normal incidence when the backside air layer was made to be 20 mm, the representative frequency being 900 Hz. FIG. 63 is a graph of results of measurements made during testing performed under conditions of normal incidence when the backside air layer was made to be 40 mm, the representative frequency being 600 Hz.

Because the foregoing embodiment makes it possible for vented chamber(s) 6 to be formed by folded portion(s). this makes it possible to reduce thickness in the Z direction of vented chamber(s) 6, as a result of which it is possible to reduce the thickness of front face portion 2.

The material at front face piece 15 is not limited to galvanized sheet iron, stainless steel, aluminum, or other metal material, but may be polycarbonate, PET, or other such plastic material.

Because front face portion 2 is constituted from front face piece(s) 15 having folded structure(s), improvement in strength is permitted despite the reduction in thickness.

Because the fractional open area of front face portion 2 is extremely low, this makes it possible for the surface to be imparted with novel value-added features. For example, electromagnetic-/acoustic-wave-absorbing panels, underbridge/underground passageway noise/ETC electromagnetic wave countermeasures, tunnel interior sound-absorbing panels, and tunnel interior illumination may be cited.

The present invention is not limited to that which has been indicated at the foregoing respective embodiments or to that which has been indicated at the test pieces.

The scope of the present invention is not as described above but is as indicated by the claims, and includes all variations within the scope of or equivalent in meaning to that which is recited in the claims.

### EXPLANATION OF REFERENCE NUMERALS

1 Sound-absorbing member
2 Front face portion
2a Front face aluminum plate
2b Corrugating aluminum angle plate
2c Aluminum plate
2d Folded portion
2e Planar portion
2f Support frame
2g Securing rivet
3 Backside air layer
4 Back face portion
4a Back face panel
4b Top face panel
4c Bottom face panel
4d Rib
4e Rib
5 Slit
6 Vented chamber
7 Linerboard
8 Corrugating medium
9 Form
10 Piece
11 Rim edging material
12 Sound-absorbing material
13 Surface material
14 Linerboard
15 Front face piece
16 Additional slits
17 Aluminum frame
18 Spandrel-type aluminum form

1. A sound-absorbing member having a front face portion toward a sound source and having an X-Y plane, and a back face portion arranged such that a backside air layer having a thickness in a Z direction intervenes between the back face portion and said front face portion;
wherein, at the front face portion, a plurality of slits that communicate with the backside air layer and that are of prescribed lengths are provided at prescribed spacings, and vented chambers which induce and contain diffracted waves from sound incident thereon from said slits are provided so as to lie in the X-Y plane and have prescribed thicknesses in the Z direction.

2. The sound-absorbing member according to claim 1 wherein the vented chambers are partitioned into a plurality thereof in the Y direction and are continuous in the X direction; and
the slits are linear, and intersect the X direction at 45 degrees to 135 degrees.

3. The sound-absorbing member according to claim 2 wherein multiple layers of the vented chambers are provided in the Z direction.

4. The sound-absorbing member according to claim 2 wherein the front face portion is formed from corrugated board, metal material, or synthetic resin material.

5. The sound-absorbing member according to claim 4 wherein sound-absorbing material is contained within the vented chambers.

6. The sound-absorbing member according to claim 1 wherein the vented chambers are partitioned into a plurality thereof in the Y direction and are continuous in the X direction; and
the slits are linear, and are parallel to the X direction.

7. The sound-absorbing member according to claim 6 wherein the plurality of slits of the prescribed lengths in the X direction are formed at the prescribed spacings so as to lie along a straight line at locations which are prescribed distances in the Y direction from top and bottom ends in the Y direction at a flat plate having the X-Y plane;
the ends in the Y direction of the flat plate are formed so as to be folded back upon themselves by 180 degrees at the locations of the slits to form a front face piece;
the front face piece is one of a plurality thereof which comprise multiple segments that are arranged so as to be in intimate contact in the Y direction to constitute the front face portion; and
the folded portions of the front face pieces constitute the vented chambers.
